(19) United States
(12) Patent Application Publication
(10) Pub. No.: US 2017/0280406 A1
(43) Pub. Date: Sep. 28, 2017

(54) SYNCHRONIZATION METHOD AND APPARATUS FOR V2X COMMUNICATIONS

(71) Applicant: Sharp Laboratories of America, Inc., Camas, WA (US)

(72) Inventor: Jia SHENG, Vancouver, WA (US)

(21) Appl. No.: 15/469,103

(22) Filed: Mar. 24, 2017

Related U.S. Application Data
(60) Provisional application No. 62/313,600, filed on Mar. 25, 2016.

(51) Int. Cl. H04W 56/00; H04W 4/00; H04W 4/04; H04W 16/10

(52) U.S. Cl. CPC H04W 56/0025; H04W 16/10; H04W 4/005; H04W 4/046; H04W 88/04

(57) ABSTRACT

A user equipment (UE) comprises control circuitry and transmission circuitry. The control circuitry may be configured to select one sidelink synchronization signal (SLSS) sequence from multiple SLSS sequences. The transmission circuitry may be configured to transmit SLSS which is generated by using the selected SLSS sequence. The multiple SLSS sequences may consist of a first subset and a second subset, the first subset being for in-network-coverage, the second subset being for out-of-network-coverage. The first subset may include a third subset, the third subset corresponding to Global Navigation Satellite System (GNSS) timing.

This application claims the priority and benefit of U.S. Provisional Patent Application 62/313,600, filed Mar. 25, 2016, entitled “SYNCHRONIZATION METHOD AND APPARATUS FOR VEHICLE (V2X) COMMUNICATIONS”, which is incorporated herein by reference in its entirety.

### TECHNICAL FIELD

The technology relates to wireless communications, and particularly to synchronization for vehicle (V2X) communication.

### BACKGROUND

When two user equipment terminals (e.g., mobile communication devices) of a cellular network or other telecommunication system communicate with each other, their data path typically goes through the operator network. The data path through the network may include base stations and/or gateways. If the devices are in close proximity with each other, their data path may be routed locally through a local base station. In general, communications between a network node such as a base station and a wireless terminal is known as “WAN” or “Cellular communication”.

It is also possible for two user equipment terminals in close proximity to each other to establish a direct link without the need to go through a base station. Telecommunications systems may use or enable device-to-device (“D2D”) communication, in which two or more user equipment terminals directly communicate with one another. In D2D communication, voice and data traffic (referred to herein as “communication signals” or “communications”) from one user equipment terminal to one or more other user equipment terminals may not be communicated through a base station or other network control device of a telecommunication system. “Device-to-device (“D2D”) communication may also be known as “sidelink direct” communication (e.g., sidelink communication), or even as “sidelink”, “SL”, or “SLD” communication.

D2D or sidelink direct communication can be used in networks implemented according to any suitable telecommunications standard. A non-limiting example of such as standard is the 3rd Generation Partnership Project (“3GPP”) Long Term Evolution (“LTE”). The 3GPP standard is a collaboration agreement that aims to define globally applicable technical specifications and technical reports for third and fourth generation wireless communication systems. The 3GPP may define specifications for next generation mobile networks, systems, and devices.

The 3GPP LTE-A system has specified a feature that provides for the support of efficient communications of small data objects between Transmit and Receive devices. Such LTE-A communication of small data objects between Transmit and Receive devices is known as Machine Type Communications (MTC). In this case, the transmitting device may be an eNB and the receiving data may be a UE, or vice-versa.

The 3GPP LTE-A system has also specified a feature that provides for the support of direct communications between transmit and receive devices, known as Proximity Services (ProSe). Proximity services consists of two main elements: network assisted discovery of transmit and receive devices that are in close physical proximity and the facilitation of direct communication between such transmit and receive devices with, or without, supervision from the network. Direct communication means a radio connection is established between the transmit device and the receive device without transiting via the network. This direct communication protocol is also known as the aforementioned sidelink. In direct communication, the transmitting device may be a user equipment (UE) and the receiving data may also be a user equipment.

Currently 3GPP is specifying a new feature for Rel-14 that covers use cases and potential requirements for LTE support for vehicular communications services (represented by the term, Vehicle-to-Everything (V2X) Services). The feature is documented in the TR 22.885 on LTE Study on LTE Support for V2X Services. The documents provide definitions for the following terms:
Road Side Unit: An entity supporting V2I Service that can transmit to, and receive from a UE using V2I application. RSU is implemented in an eNB or a stationary UE.
V2I Service: A type of V2X Service, where one party is a UE and the other party is an RSU both using V2I application.
V2P Service: A type of V2X Service, where both parties of the communication are UEs using V2P application.
V2V Service: A type of V2X Service, where both parties of the communication are UEs using V2V application.
V2X Service: A type of communication service that involves a transmitting or receiving UE using V2V application via 3GPP transport. Based on the other party involved in the communication, it can be further divided into V2V Service, V2I Service, V2P Service, and V2N Service.

What is needed are methods, apparatus, and/or techniques for providing sync providing synchronization for vehicle (V2X) communication.

### SUMMARY

In an example embodiment and mode the technology disclosed herein concern a wireless terminal comprises processor circuitry and a transmitter. The processor circuitry is configured prepare content for a synchronization signal for a wireless vehicle direct (V2X) communications by making a selection of a selected synchronization sequence from a set of synchronization sequences, the selection being dependent upon synchronization-affecting information used for the V2X communication. The transmitter is configured to transmit the synchronization signal comprising the selected synchronization sequence over a radio interface.

In some example embodiment and modes the synchronization-affecting information may be carried by a broadcast channel.

In an example embodiment and mode the technology disclosed herein concerns a user equipment (UE) comprising control circuitry and transmission circuitry. The control circuitry may be configured to select one sidelink synchronization signal (SLSS) sequence from multiple SLSS sequences. The transmission circuitry may be configured to transmit SLSS which is generated by using the selected SLSS sequence. The multiple SLSS sequences may consist of a first subset and a second subset, the first subset being for in-network-coverage, the second subset being for out-of-network-coverage. The first subset may include a third subset, the third subset corresponding to Global Navigation Satellite System (GNSS) timing.

### BRIEF DESCRIPTION OF THE DRAWINGS

The foregoing and other objects, features, and advantages of the technology disclosed herein will be apparent from the following more particular description of preferred embodiments as illustrated in the accompanying drawings in which reference characters refer to the same parts throughout the various views. The drawings are not necessarily to scale, emphasis instead being placed upon illustrating the principles of the technology disclosed herein.

FIG. 1 is a diagrammatic view showing generally three scenarios which may occur in vehicle (V2X) communication, i.e., an in coverage vehicle (V2X) communication scenario; a partial coverage vehicle (V2X) communication scenario; and an out-of-coverage vehicle (V2X) communication scenario.

FIG. 2 is a diagrammatic view showing that, in differing implementations, V2X communication may be implemented either in conjunction with sidelink direct (SLD) communication, in conjunction with enhanced SLD, or apart from SLD as a separate V2X communication protocol.

FIG. 3 is a schematic view of a wireless terminal suitable which prepares and/or uses a selected synchronization sequence, selected from a set of synchronization sequences, which indicates or provides certain synchronization-affecting information used for V2X communication.

FIG. 4A is a flowchart depicting basic, example acts or steps involved in generic method of operating a wireless terminal which generates a synchronization signal using a selected synchronization sequence in order to provide certain synchronization-affecting information used for V2X communication.

FIG. 4B is a flowchart depicting basic, example acts or steps involved in generic method of operating a wireless terminal which obtains, from a synchronization signal, a synchronization sequence which was selected in order to provide certain synchronization-affecting information used for V2X communication.

FIG. 5 is a schematic view of a synchronization controller according to an example embodiment that uses identification of a timing source as the synchronization-affecting information.

FIG. 6A, FIG. 6B, and FIG. 6C are diagrammatic viewing showing differing implementations of configuration of synchronization sequence subset configuration for the example embodiment of FIG. 5.

FIG. 7 is a schematic view of a synchronization controller according to an example embodiment that uses identification of a service type as the synchronization-affecting information.

FIG. 8A, FIG. 8B, FIG. 8C, FIG. 8D(1), FIG. 8D(2), FIG. 8E(1), FIG. 8E(2), and FIG. 8F are diagrammatic viewing showing differing implementations of configuration of synchronization sequence subset configuration for the example embodiment of FIG. 7.

FIG. 9 is a schematic view of a wireless terminal according to an example embodiment that includes an identification of a service type in a broadcast channel.

FIG. 10 is a schematic view of a synchronization controller according to an example embodiment that uses identification of a range of vehicle speed or velocity as the synchronization-affecting information.

FIG. 11A, FIG. 11B, FIG. 11C, and FIG. 11D are diagrammatic views showing differing implementations of configuration of synchronization sequence subset configuration for the example embodiment of FIG. 10.

FIG. 12 is a schematic view of a wireless terminal according to an example embodiment that includes an identification of a range of vehicle speed or velocity in a broadcast channel.

FIG. 13 is a schematic view of a wireless terminal suitable which prepares and/or uses a selected synchronization sequence, selected from a set of synchronization sequences, which indicates or provides plural synchronization-affecting information used for V2X communication.

FIG. 14 is a diagrammatic viewing showing an example implementation of configuration of synchronization sequence subset configuration for the example embodiment of FIG. 13.

FIG. 15 is a diagrammatic view showing example elements comprising electronic machinery which may comprise a wireless terminal according to an example embodiment and mode

### DETAILED DESCRIPTION

In the following description, for purposes of explanation and not limitation, specific details are set forth such as particular architectures, interfaces, techniques, etc. in order to provide a thorough understanding of the technology disclosed herein. However, it will be apparent to those skilled in the art that the technology disclosed herein may be practiced in other embodiments that depart from these specific details. That is, those skilled in the art will be able to devise various arrangements which, although not explicitly described or shown herein, embody the principles of the technology disclosed herein and are included within its spirit and scope. In some instances, detailed descriptions of well-known devices, circuits, and methods are omitted so as not to obscure the description of the technology disclosed herein with unnecessary detail. All statements herein reciting principles, aspects, and embodiments of the technology disclosed herein, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that block diagrams herein can represent conceptual views of illustrative circuitry or other functional units embodying the principles of the technology. Similarly, it will be appreciated that any flow charts, state transition diagrams, pseudocode, and the like represent various processes which may be substantially represented in computer readable medium and so executed by a computer or processor, whether or not such computer or processor is explicitly shown.

As used herein, the term “device-to-device (“D2D”) communication” may refer to a mode of communication between or among wireless terminals that operate on a cellular network or other telecommunications system in which the communication data traffic from one wireless terminal to another wireless terminal does not pass through a centralized base station or other device in the cellular network or other telecommunications system. The “device-to-device (D2D) communication” encompasses one or both of D2D signaling (e.g., D2D control information) and D2D data. “Device-to-device (“D2D″) communication may also be known as “sidelink direct” communication (e.g., sidelink communication). The term “sidelink direct” may also be shortened to “sidelink”, abbreviated as “SL”, and as such “sidelink” may be used herein to refer to sidelink direct. Yet further, the term “ProSe” (Proximity Services) direct communication may be used in lieu of sidelink direct communication or device-to-device (D2D) communication. Therefore, it is to be understood that herein the terms “sidelink direct”, ‘sidelink” (SL), “ProSe” and “device-to-device (D2D)” may be interchangeable and synonymous.

Thus, as mentioned above, device-to-device (D2D) or sidelink direct communication differs from “WAN” or “Cellular communication” which is or involves communication between the base station and the wireless terminal. In device-to-device (D2D) communication, communication data is sent using communication signals and can include voice communications or data communications intended for consumption by a user of a wireless terminal. Communication signals may be transmitted directly from a first wireless terminal to a second wireless terminal via D2D communication. In various aspects, all, some or none of the control signaling related to the D2D packet transmission may be managed or generated by the underlying core network or base station. In additional or alternative aspects, a receiver user equipment terminal may relay communication data traffic between a transmitter user equipment terminal and one or more additional receiver user equipment terminals.

As used herein, the term “core network” can refer to a device, group of devices, or sub-system in a telecommunication network that provides services to users of the telecommunications network. Examples of services provided by a core network include aggregation, authentication, call switching, service invocation, gateways to other networks, etc.

As used herein, the term “wireless terminal” can refer to any electronic device used to communicate voice and/or data via a telecommunications system, such as (but not limited to) a cellular network. Other terminology used to refer to wireless terminals and non-limiting examples of such devices can include user equipment terminal, UE, mobile station, mobile device, access terminal, subscriber station, mobile terminal, remote station, user terminal, terminal, subscriber unit, cellular phones, smart phones, personal digital assistants (“PDAs”), laptop computers, netbooks, e-readers, wireless modems, etc.

As used herein, the term “access node”, “node”, or “base station” can refer to any device or group of devices that facilitates wireless communication or otherwise provides an interface between a wireless terminal and a telecommunications system. A non-limiting example of a base station can include, in the 3GPP specification, a Node B (“NB”), an enhanced Node B (“eNB”), a home eNB (“HeNB”) or some other similar terminology. Another non-limiting example of a base station is an access point. An access point may be an electronic device that provides access for wireless terminal to a data network, such as (but not limited to) a Local Area Network (“LAN”), Wide Area Network (“WAN”), the Internet, etc. Although some examples of the systems and methods disclosed herein may be described in relation to given standards (e.g., 3GPP Releases 8, 9, 10, 11, 12, and thereafter), the scope of the present disclosure should not be limited in this regard. At least some aspects of the systems and methods disclosed herein may be utilized in other types of wireless communication systems.

As used herein, the term “telecommunication system” or “communications system” can refer to any network of devices used to transmit information. A non-limiting example of a telecommunication system is a cellular network or other wireless communication system.

As used herein, the term “cellular network” or “cellular radio access network” can refer to a network distributed over cells, each cell served by at least one fixed-location transceiver, such as a base station. A “cell” may be any communication channel that is specified by standardization or regulatory bodies to be used for International Mobile Telecommunications-Advanced (“IMTAdvanced”). All or a subset of the cell may be adopted by 3GPP as licensed bands (e.g., frequency band) to be used for communication between a base station, such as a Node B, and a UE terminal. A cellular network using licensed frequency bands can include configured cells. Configured cells can include cells of which a UE terminal is aware and in which it is allowed by a base station to transmit or receive information. Examples of cellular radio access networks include EUTRAN (“Evolved Universal Terrestrial Radio Access Network”) and its successor technologies, e.g., such as a “NUTRAN” (“New Universal Terrestrial Radio Access Network”), for example.

Vehicle (V2X) communication is described in one or more of the following (all of which are incorporated herein by reference in their entirety):

### RP-151109, Feasibility Study on LTE-based V2X Services

RP-152293, Support for V2V services based on LTE sidelink
R1-161072, Distributed Synchronization Procedure for V2X over PC5, Ericsson

### R1-160734, Timing Alignment of Different Synchronization Sources for V2V, Huawei

### R1-160758, SLSS and PSBCH Design for V2V, Huawei

### R1-1610152, SLSS Enhancement for GNSS Based Synchronization, NTT Docomo

R1-160577, Discussions on synchronization for PC5 based V2V, Samsung
R1-160360, Synchronization enhancements in PC5-based V2V, CATT

### 3GPP TR 22.885 V0.4.0 3rd Generation Partnership Project; Technical Specification Group Services and System Aspects; Study on LTE Support for V2X Services (Release 14)

Vehicle (V2X) communication is a communication that involves a radio connection established between a transmit device and a receive device (e.g., a wireless terminal or UE), which radio communication need not transit via a base station node of the network, with at least of one the transmit device and the receive device being mobile, e.g., capable of being moved. Generic V2X encompasses one or more of vehicle to infrastructure (V2I) communication; vehicle to person/pedestrian (V2P) communication; and vehicle to vehicle (V2V) communication.

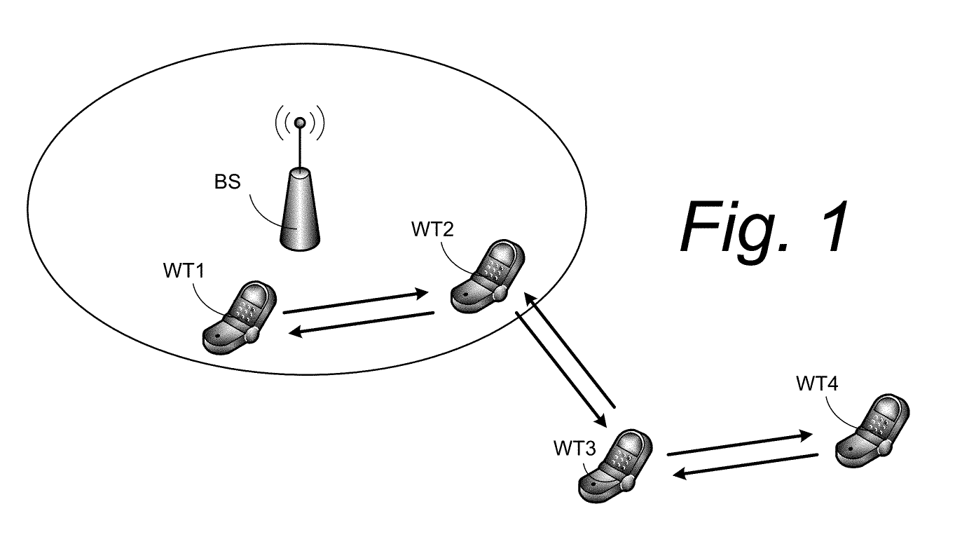

Generally, there are three general scenarios which may occur in vehicle (V2X) communication. Those three general vehicle (V2X) communications scenarios are illustrated in FIG. 1. A first vehicle (V2X) communication scenario is an “in coverage” vehicle (V2X) communication scenario, illustrated between WT1 and WT2 of FIG. 1, in which both WT1 and WT2 are within coverage of the cellular radio access network. A second vehicle (V2X) communication scenario is a “partial coverage” scenario, illustrated between WT2 and WT3 of FIG. 1. In the “partial coverage” vehicle (V2X) communication scenario the wireless terminal WT2 is within coverage of the cellular radio access network, but the wireless terminal WT3 is out-of-coverage of the cellular radio access network. A third vehicle (V2X) communication scenario is an “out-of-coverage” scenario, illustrated between wireless terminal WT3 and wireless terminal WT4 of FIG. 1. In the out-of-coverage vehicle (V2X) communication scenario both the wireless terminal WT3 and the wireless terminal WT4 are out-of-coverage of the cellular radio access network.

The three vehicle (V2X) communication scenarios are described with reference to whether or not a participating wireless terminals (e.g., WTs) are “in coverage” or “out-of-coverage” of one or more cellular radio access networks (which may collectively be referred to as a “cellular radio access network”). For sake of simplicity FIG. 1 depicts “coverage” as being with respect to an access node BS such as eNodeB which comprises a cellular radio access network. It should be understood, however, that a wireless terminal may also be in coverage of the cellular radio access network when served by any cell of the cellular radio access network(s). For example, if wireless terminal WT1 and wireless terminal WT2 were served by different cells, when participating in vehicle (V2X) communication the wireless terminal WT1 and wireless terminal WT2 would still be in an in coverage vehicle (V2X) communication scenario.

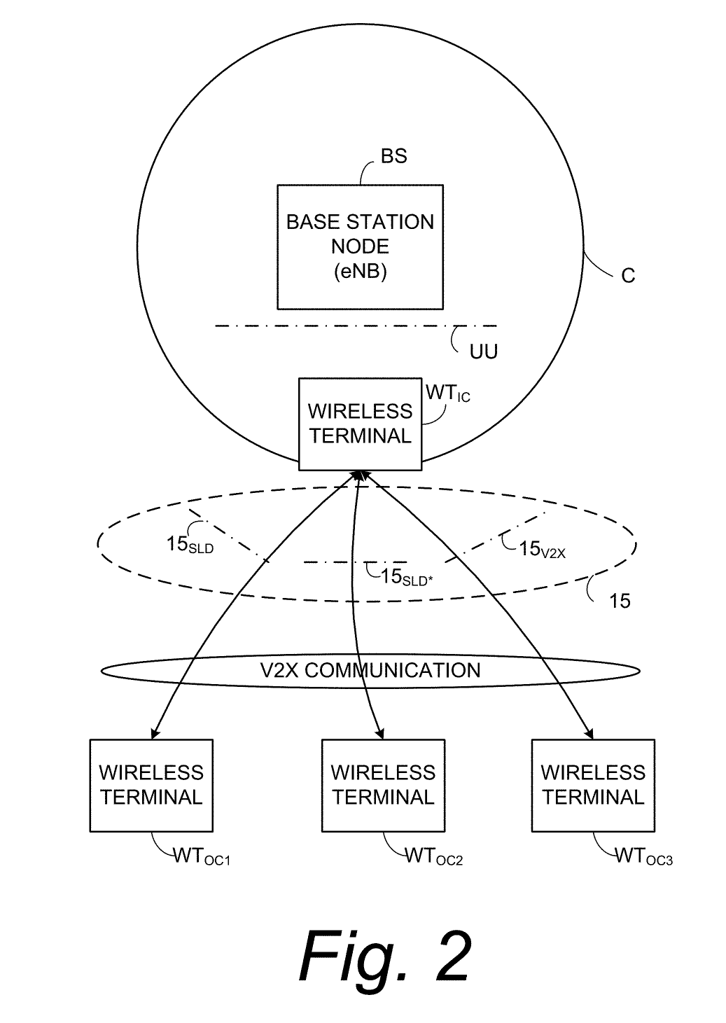

As used herein and as illustrated in FIG. 2, V2X communication may be implemented in several ways. For illustrative context, FIG. 2 illustrates a base station node BS of a cellular radio access network which serves a cell C. The base station BS may communicate with a wireless terminal WT_{IC} which is in coverage of the cellular radio access network over a radio interface UU. FIG. 2 further shows that wireless terminal WT_{IC} may engage in vehicle (V2X) communication with one or more other wireless terminals which are outside of coverage of the cellular radio access network, particularly wireless terminal WT_{OC1}, wireless terminal WT_{OC2, and} wireless terminal WT_{OC3}. It is assumed that either wireless terminal WT_{IC}, or all of wireless terminal WT_{OC1}, wireless terminal WT_{OC2}, and wireless terminal WT_{OC3} are mobile terminals for the communication to be vehicle (V2X) communication. Being “mobile” means that the wireless terminal is provided or situated in/with a mobile entity, such as a vehicle or a person.

As a first example implementation, V2X communication may be implemented using applications and resources of the type that were utilized for sidelink direct (SLD) communication (also known as device-to-device (“D2D”) communication) before introduction of vehicle (V2X) communication. For example, when implemented as part of SLD communication the V2X communication may use resources and channels of the SLD communication scheme. In such first implementation the V2X communication may be said to be implemented using pre-V2X sidelink direct (SLD) protocol and over a pre-V2X sidelink direct (SLD) radio interface 15SLD.

As a second example implementation, V2X communication may be implemented using enhanced applications and enhanced resources utilized for sidelink direct (SLD) communication, e.g., sidelink direct communications augmented or enhanced with additional capabilities to accommodate vehicle (V2X) communication. In such second implementation the V2X communication may be said to be implemented using enhanced sidelink direct (SLD) protocol and over an enhanced sidelink direct (SLD) radio interface 15SLD*.

As a third example implementation, V2X communication may operate separately from sidelink direct (SLD) communication by, e.g., having separate and dedicated V2X communication resources and channels, and by being performed using application software which is specific to V2X communication. In such third implementation the V2X communication may be said to be implemented using separate vehicle (V2X) communications protocol and over a separate vehicle (V2X) communication radio interface 15V2X.

The fact that three example implementations are illustrated in FIG. 2 does not mean that a particular wireless terminal has to participate in all three or even two of the example implementations. FIG. 2 simply indicates the expansive meaning of the term vehicle (V2X) communication and that the technology disclosed herein encompasses vehicle (V2X) communication in all of its various existing and potential implementations.

A concern for PC5-based V2X synchronization signal (SS) design is: comparing with SLSS, based on the fundamental principle that the amount of required new information should be minimized, what extra information should be carried by V2X SS? For PC5-based V2X synchronization signal (SS) design is meant, e.g., V2X SS and its associated broadcast information design; as for D2D, each sidelink synchronization signal (SLSS) transmission is associated with a PSBCH transmission, which carries necessary message for system information including synchronization required information).

Since V2X and D2D are two different services, they should at least be distinguished in the application layer. V2X and D2D should be distinguished from each other by: synchronization, because they have different service type and service requirements, and the system information (broadcasted by PSBCH for D2D and similar channel for V2X) should be different. If V2X and D2D co-exist in the same area, they should only decode their own type of broadcasting information, at no cost of reading unnecessary broadcast information of a different service. Therefore, service type (V2V, or V2P, or V2I, or D2D) should be another new information worthy of consideration.

Since a V2X UE is normally in the motion with speed, or even relatively bi-directional high speed motion with regard to communicating or synchronizing to other V2X UEs also in motion. High speed may introduce severe Doppler shift effect which may degrade received synchronization signal timing accuracy. When the UE selects which synchronization source to be used as timing, it will be better to know the speed of the source.

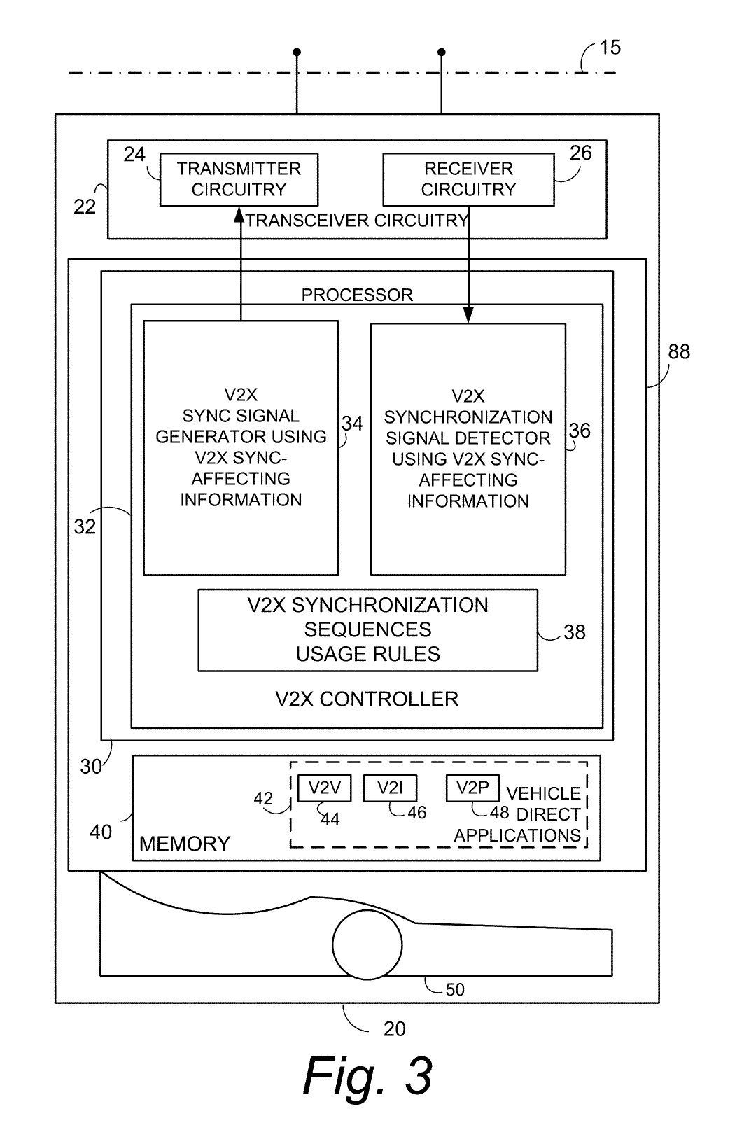

Described herein are apparatus, method, and technique for synchronizing V2X communications, and particularly the preparation and use of a selected synchronization sequence, selected from a set of synchronization sequences, which indicates or provides certain synchronization-affecting information used for the V2X communication. A synchronization-affecting parameter is an example of a synchronization-affecting information, and the two terms may be used interchangeably herein. FIG. 3 shows an example embodiment of wireless terminal 20 which participates in vehicle (V2X) communication and which functions as a synchronization source for vehicle (V2X) communication. As understood with reference to the preceding discussion of FIG. 2, the wireless terminal 20 may be either totally within network coverage, partially within network coverage, or outside of network coverage.

The wireless terminal 20 of FIG. 3 includes transceiver circuitry 22 for radio communication across vehicle (V2X) communication radio interface 15. Vehicle (V2X) communication radio interface 15 may be a pre-V2X sidelink direct (SLD) radio interface 15SLD, an enhanced sidelink direct (SLD) radio interface 15SLD*, or a separate vehicle (V2X) communication radio interface 15V2X as previously explained with reference to FIG. 1. The transceiver circuitry 22 in turn comprises transmitter circuitry 24 and receiver circuitry 26. The transceiver circuitry 22 includes antenna(e) for the wireless terminal 20. Transmitter circuitry 24 includes, e.g., a frame generator, amplifier(s), modulation circuitry and other conventional transmission equipment. Receiver circuitry 26 comprises, e.g., demodulation circuitry, a frame deformatter, and other conventional receiver equipment. The transceiver circuitry 22 is configured to use resources allocated for V2X communication, whether those resources be shared with sidelink direct (SLD) communications, resources of enhanced sidelink direct (SLD) communications, or resources separate and distinct for V2X communication as previously described.

The wireless terminal 20 also includes processor circuitry 30 which in turn, among other functionalities of wireless terminal 20, serves as V2X controller 32. The processor circuitry may also be simply referred to as “processor”. The V2X controller 32 comprises synchronization signal generator 34 and synchronization signal detector 36. The V2X controller 32 also comprises or has access to a bank or pool of V2X synchronization sequence usage rules 38. In an example embodiment and mode, processor 30 and V2X controller 32 in particular is configured to perform executable instructions stored in non-transient memory.

In the above regard, wireless terminal 20 also comprises memory 40 (e.g., memory circuitry) which may store an operating system and various application programs, such as vehicle communication applications 42, and the V2X synchronization sequence usage rules 38. The memory 40 may be any suitable type of memory, e.g., random access memory (RAM), read only memory (ROM), cache memory, processor register memory, or any combination of one or more memory types. The vehicle communication applications 42 comprise instructions executable by processor 30 and are stored in non-transient portions of memory 40. The vehicle communication applications 42 may include V2V (vehicle-to-vehicle) application 44, VDI (vehicle-to-infrastructure) application 46, and V2P (vehicle-to-pedestrian) application 48.

The wireless terminal 20 further comprises user interface(s) 50. The user interfaces 50 may comprise one or more suitable input/output devices which are operable by a user. Some of all of the user interfaces 50 may be realized by a touch sensitive screen. Only a portion of the user interfaces 50 is depicted in FIG. 3, it being understood that the user interfaces 50 may be provided on a cover or case of wireless terminal 20 and thus may visibly obscure the underlying other components shown in FIG. 3.

The synchronization signal generator 34 of the wireless terminal 20 of FIG. 3 is configured to generate a synchronization signal which not only facilitates synchronization timing for the vehicle (V2X) communication, but also includes certain synchronization-affecting information used for the V2X communication. Accordingly, synchronization signal generator 34 is illustrated in FIG. 3 as being a V2X sync signal generator using V2X synchronization-affecting information (for generating a synchronization signal).

In particular, the synchronization signal generator 34 is configured to select, for use in the synchronization signal, a synchronization sequence which indicates or provides the synchronization-affecting information used for the V2X communication. The synchronization sequence is selected from a set of synchronization sequences that are available or known to the synchronization signal generator 34. Members of the set of synchronization sequences are identified by a synchronization sequence identifier (“ID”).

In one particular technique the set of synchronization sequences comprises two sets of synchronization sequence identities, a first set consisting of consisting of identities {0, 1, . . . , 167} and a second set consisting of identities {168, 169, . . . , 335}. The V2X synchronization sequences are generated using two expressions, a first expression being N_{ID}⁽¹⁾=N_{ID}^{V2X} mod 168[N_{ID}⁽¹⁾ε{0, 1, . . . , 167}, and a second expression being N_{ID}⁽²⁾=└N_{ID}^{V2X}/168┘[N_{ID}⁽²⁾ε{0, 1}]. The use of these two expressions determines the resultant V2X synchronization sequence N_{ID}^{V2X}=N_{ID}⁽²⁾*168+N_{ID}⁽¹⁾. Typically, in this nomenclature N_{ID}^{V2X} represents the V2X synchronization sequence (V2XSS) ID, with N_{ID}⁽²⁾ representing the V2X primary synchronization sequence (PSS) ID and Ng representing the V2X secondary synchronization sequence (SSS) ID.

As used herein, the identity of a particular V2X synchronization sequence included in a synchronization signal also carries the synchronization-affecting information. In differing embodiments and modes, the synchronization-affecting information used for the V2X communication has corresponding different significance. For example, in a first example embodiment and mode the synchronization-affecting information indicates a timing source used by the wireless terminal 20 for the vehicle (V2X) communication; in a second embodiment the synchronization-affecting information indicates a service type for the vehicle communications; for a third example embodiment and mode the synchronization-affecting information indicates a speed or velocity range for the wireless terminal 20 that serves as a synchronization source for vehicle (V2X) communication.

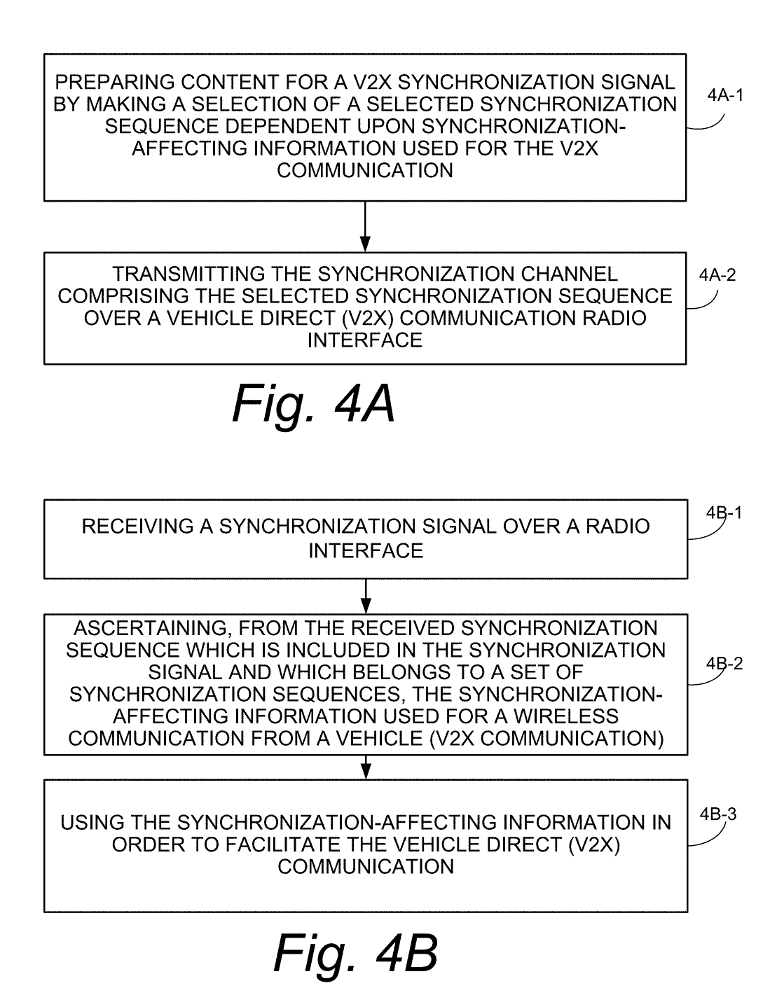

FIG. 4A illustrates basic, representative acts or steps performed in accordance with an example mode of a method of operating wireless terminal 20. In fact, the acts of FIG. 4A may be acts performed by processor 30 when executing a vehicle communication applications 42, and particularly acts performed by synchronization signal generator 34 in generating a synchronization signal. Act 4A-1 comprises the synchronization signal generator 34 preparing content for a synchronization signal for wireless vehicle (V2X) communication, which act is accomplished by the synchronization signal generator 34 making a selection of a selected synchronization sequence from a set of synchronization sequences. As mentioned above, the selection being dependent upon synchronization-affecting information used for the V2X communication. Act 4A-2 comprises the transmitter 24 transmitting the synchronization signal comprising the selected synchronization sequence over a radio interface, e.g., over the V2X radio interface 15.

Conversely synchronization signal detector 36 of the wireless terminal 20 of FIG. 3 is configured to decode a synchronization signal and thereby not only obtain synchronization timing for the vehicle (V2X) communication, but also to obtain the certain synchronization-affecting information used for the V2X communication. Accordingly, synchronization signal detector 36 is illustrated in FIG. 3 as being a V2X sync signal detector using V2X synchronization-affecting information (for decoding a synchronization signal). In particular, the synchronization signal detector 36 obtains, from a received synchronization signal, a synchronization sequence which indicates or provides the synchronization-affecting information used for the V2X communication. The synchronization sequence is matched with a synchronization sequence from the set of synchronization sequences that are available or known to the synchronization signal generator 34. Members of the set of synchronization sequences are identified by a synchronization sequence identifier (“ID”), which may have the identities or identifiers 1 . . . 335 as described above. As with the generation of the V2X synchronization sequences, the identity of a particular V2X synchronization sequence received in a synchronization signal also carries the synchronization-affecting information. As indicated above, in differing embodiments and modes, the synchronization-affecting information used for the V2X communication has corresponding different significance (e.g., timing source used, service type, velocity range, as summarized above and described in more detail below).

FIG. 4B illustrates basic, representative acts or steps performed in accordance with an example mode of a method of operating wireless terminal 20. In fact, the acts of FIG. 4B may be acts performed by processor 30 when executing a vehicle communication applications 42, and particularly acts performed by synchronization signal detector 36 in receiving and obtaining a synchronization signal. Act 4B-1 comprises the wireless terminal 20, and particularly receiver 26, receiving a synchronization signal over a radio interface (e.g., the V2X interface 15). Act 4B-2 comprises ascertaining, from the received synchronization sequence which is included in the synchronization signal and which belongs to a set of synchronization sequences, the synchronization-affecting information used for vehicle (V2X communication).

Act 4C-1 comprises the wireless terminal 20 using the synchronization-affecting information in order to facilitate the vehicle (V2X) communication. Both synchronization signal generator 34 and synchronization signal detector 36 are shown in the particular wireless terminal 20 of FIG. 3. However, it should be appreciated that, depending on purpose and function of the wireless terminal 20, only one of synchronization signal generator 34 and synchronization signal detector 36 may be provided. For example, only synchronization signal generator 34 may be provided in the wireless terminal 20 in an example embodiment and mode in which the wireless terminal 20 may serve as a synchronization source but not necessarily receive a synchronization signal from another wireless terminal across the vehicle (V2X) communication radio interface 15. On the other hand, if it is not envisioned that a particular wireless terminal 20 may be a synchronization source, only the synchronization signal detector 36 may be provided in that wireless terminal 20.

Timing Source Embodiments

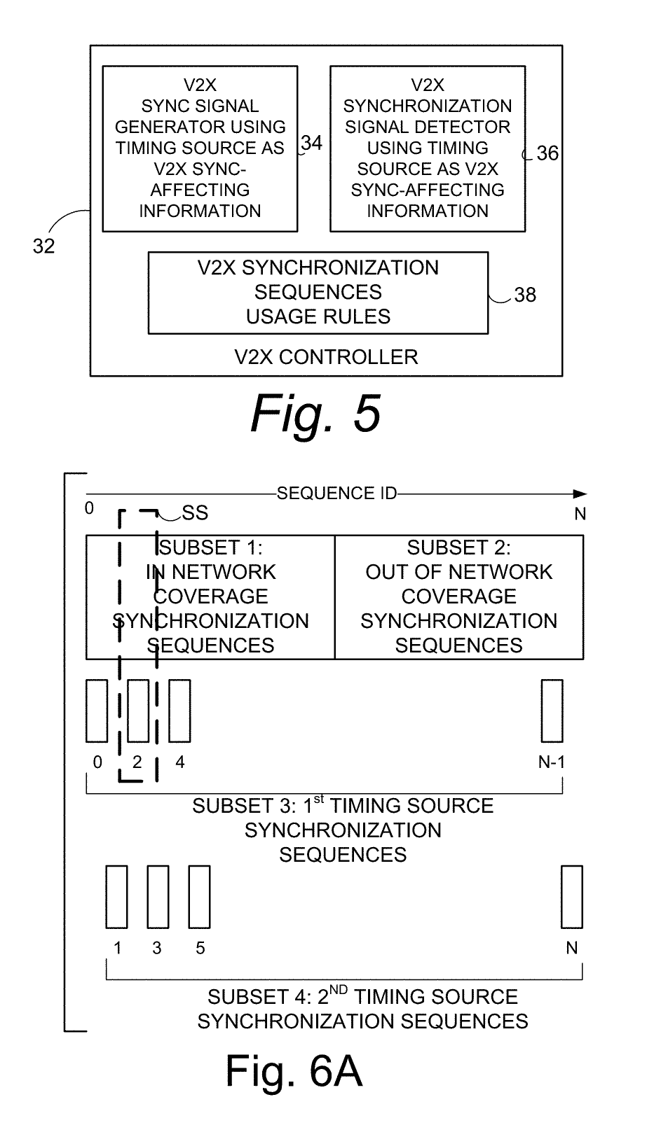

As mentioned above, in differing embodiments and modes the synchronization-affecting information used for the V2X communication has corresponding different significance. In first example embodiments and modes, illustrated generically in FIG. 5, the synchronization-affecting information indicates a timing source used by the wireless terminal 20 for the vehicle (V2X) communication. FIG. 5 shows an example embodiment in which the V2X controller 32 comprises one or both of synchronization signal generator 34 and synchronization signal detector 36 that uses identification of a timing source as the synchronization-affecting information.

In the FIG. 5 example embodiments, the set of synchronization sequences available to synchronization signal generator 34 for synchronization signal generation, and to synchronization signal detector 36 for decoding of a received synchronization signal, comprises a subset of V2X synchronization sequences for which timing for the V2X communication is obtained with respect to a first timing source; and a subset of V2X synchronization sequences for which timing for the V2X communication is obtained with respect to a second timing source. In an example embodiment and mode, the first timing source is a timing source which is available throughout a cellular radio access network but maintained external to the cellular radio access network and the second timing source is maintained by the cellular radio access network. An example of the first timing source is a Global Navigation Satellite System (GNSS)-type timing source, such as GPS, GLONASS, Galileo or Beidou systems. Another example of the first timing source is an atomic clock type source that is available throughout the cellular radio access network.

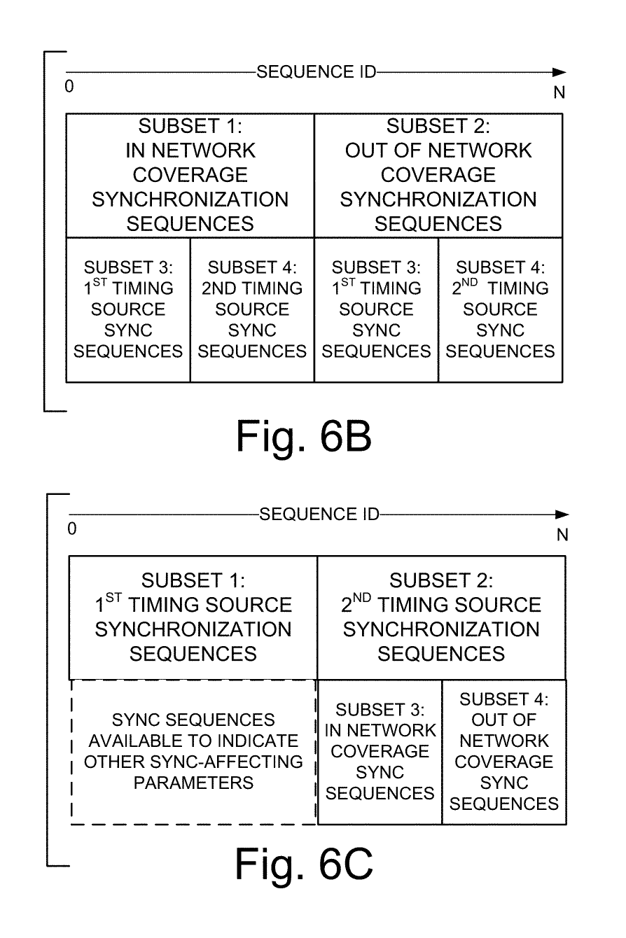

FIG. 6A shows one example implementation of the timing source embodiment and mode. FIG. 6A, like other comparable, similarly formatted drawings, shows horizontally across the figure a series of synchronization signal identifiers ranging from 0 to N. In a typical implementation, N=335 as discussed above. FIG. 6A, like other comparable, similarly formatted drawings, illustrates how a selected synchronization signal can belong to plural subsets of synchronization sequences, e.g., how a selected synchronization signal can be a member of plural subsets of synchronization sequences and thus provide plural types of information.

In the illustration of FIG. 6A, the set of synchronization sequences available to V2X controller 32 and thus defined in V2X synchronization sequence usage rules 38 comprises: (1) a first subset comprising synchronization sequences for which timing is derived from a cellular radio access network node; (2) a second subset comprising synchronization sequences for which timing is not derived from the cellular radio access network node; (3) a third subset comprising the V2X synchronization sequences for which timing for the V2X communication is obtained with respect to the first timing source; and, (4) a fourth subset comprising the V2X synchronization sequences for which timing for the V2X communication is obtained with respect to the second timing source. As illustrated in FIG. 6A, the third subset overlaps with one or both of the first and second subsets but does not overlap with the fourth subset.

As an aside, the distinction between the first subset and the second subset should be appreciated. The distinction is whether the synchronization source is one for which timing is derived from a node or not of the cellular radio access network, not the type of timing source utilized by that node or the network. As used in this context, “node” means a base station or comparable node which has capabilities of communicating across an interface such as the Uu interface with a wireless terminal, and thus in this context of the first subset and second subset a wireless terminal does not quality as a network node (although a wireless terminal may quality as a network node in other contexts). For example, a synchronization sequence may have timing derived from a node of a cellular radio access network which is using either one of the first timing source and the second timing source as its timing source. “Derived” means that the synchronization sequence was ultimately obtained from the network node, either immediately or through inheritance. Or a synchronization sequence may have timing derived from a wireless terminal of a cellular radio access network which is using either one of the first timing source and the second timing source as its timing source.

As a non-limiting example of the configuration of the third subset of synchronization sequences and the fourth subset of synchronization sequences, FIG. 6A illustrates the third subset of synchronization sequences as comprises either only odd numbered members or only even numbered members of one or both of the first subset of synchronization sequences and the second subset of synchronization sequences. For example, FIG. 6A shows the third subset of synchronization sequences as comprising the synchronization sequences which have even identifiers 0, 2, 4, . . . 334. Conversely the fourth subset of synchronization sequences are illustrated in FIG. 6A as comprising members of one or both of the first subset of synchronization sequences and second subset of synchronization sequences that do not belong to the third subset of synchronization sequences, e.g. synchronization sequences having identifiers 1, 3, 5, . . . 335.

As another non-limiting example of the configuration of the third subset of synchronization sequences and the fourth subset of synchronization sequences, FIG. 6B illustrates the third subset of synchronization sequences and the fourth subset of synchronization sequences as comprising partitions of the first subset of synchronization sequences and the second subset of synchronization sequences. For example, the third subset of synchronization sequences may comprise synchronization sequences having IDs 0-83 (a first partition of the first subset of synchronization sequences) and synchronization sequences having IDs 168-252 (a first partition of the second subset of synchronization sequences), and the fourth subset of synchronization sequences may comprise synchronization sequences having IDs 84-167 (a second partition of the first subset of synchronization sequences) and synchronization sequences having IDs 253-335 (a second partition of the second subset of synchronization sequences). Other partitioning techniques, or further ways of defining the third subset and fourth subset are also encompassed hereby.

In the example embodiments and modes of FIG. 6A and FIG. 6B and other similar embodiments and modes, the synchronization signal generator 34 of processor circuitry 30 is configured to selected the selected synchronization sequence as belonging to (a) either the first subset of synchronization sequence or the second subset of synchronization sequences; and (b) either the third subset of synchronization sequences or the fourth subset of synchronization sequences. FIG. 6A shows, for sake of non-limiting illustration, by the notation SS that a synchronization sequence having ID=2 may be chosen as the selected synchronization sequence, and that the selected synchronization sequence is a member of more than one subset of synchronization sequences. In this regard, by way of conceptualization FIG. 6A illustrates an upper “layer” of sequences comprised by first subset and second subset extending horizontally and having identifiers 1 . . . N, as well as the third subset of synchronization sequences and the fourth subset of synchronization sequences extending horizontally and also having identifiers in a lower “layer” which is vertically below the upper layer. The upper layer and lower layer actually overlap in terms of synchronization sequence identifiers. Therefore, for this particular example, the selected synchronization sequence SS has identifier 2, and thus is a member of both the first subset of synchronization sequences and the third subset of synchronization sequences. Although specific selected synchronization sequences are not illustrated in other drawings, it should be understood that in all drawings the layers are superimposed or overlap in the manner shown in FIG. 6A.

The synchronization signal detector 36 of processor circuitry 30 of FIG. 6A and FIG. 6B is configured to ascertain information regarding the timing source dependent on the received synchronization sequence belong to either the third subset of synchronization sequences or the fourth subset of synchronization sequences. Thus, in the example of FIG. 6A, the synchronization signal decoder 36 determines that the received synchronization sequence has identifier ID=2, and after consultation from V2X synchronization sequence usage rules 38 determines that the received synchronization sequence thus pertains to both the first subset of synchronization sequences and the third subset of synchronization sequences, and thus that the synchronization signal is in network coverage and uses the first timing source.

The example embodiments and modes of FIG. 6A and FIG. 6B are essentially compatible in the nature of synchronization sequence construction for sidelink direct (SLD) communications from the vantage point that the first subset comprises synchronization sequences for which timing is derived from a cellular radio access network node and the second subset comprises synchronization sequences for which timing is not derived from the cellular radio access network node, and in which synchronization sequences are generated using the two expressions N_{ID}⁽¹⁾=N_{ID}^{V2X} mod 168[N_{ID}⁽¹⁾ε{0, 1, . . . , 167}, and N_{ID}⁽²⁾=└N_{ID}^{V2X}/168┘[N_{ID}⁽²⁾ε{0, 1}] as described above. In this regard, in both FIG. 6A and FIG. 6B the upper illustrated “layer” of sequences comprised by first subset and second subset is vertically above the illustrated lower layers of the third subset and the fourth subset.

By contrast, the example implementation of FIG. 6C is essentially an inversion of the implementations of FIG. 6A and FIG. 6B, and thus is not necessarily compatible with the sidelink direct (SLD) protocol, although having other advantages. In the example implementation of FIG. 6C, the subsets available to the V2X controller 32 are: a first subset comprising V2X synchronization sequences for which timing for the V2X communication is obtained with respect to the first timing source; a second subset comprising the V2X synchronization sequences for which timing for the V2X communication is obtained with respect to the second timing source; a third subset of synchronization sequences which is a subset of the second subset of synchronization sequence and which comprises synchronization sequences for which timing is derived from a cellular radio access network node; and a fourth subset of synchronization sequences which is a subset of the second subset of synchronization sequence and which comprises synchronization sequences for which timing is not derived from the cellular radio access network node. Thus, in the implementation of FIG. 6C it is the first subset (the first timing source subset) and the second subset (the second timing source subset) that in which synchronization sequences are generated using the two expressions N_{ID}⁽¹⁾=N_{ID}^{V2X} mod 168[N_{ID}⁽¹⁾ε{0, 1, . . . , 167}, and N_{ID}⁽²⁾=└N_{ID}^{V2X}/168┘[N_{ID}⁽²⁾ε{0, 1}] as described above. In the FIG. 6C implementation, the third subset of synchronization sequences and the fourth subset of synchronization sequences do not overlap.

In the example embodiment and mode of FIG. 6C, the synchronization signal generator 34 of processor circuitry 30 is configured to selected the selected synchronization sequence as belonging to either: the first subset of synchronization sequence; or the second subset of synchronization sequences and one but not both of (b1) the third subset of synchronization sequences; and (b2) the fourth subset of synchronization sequences.

In the example embodiment and mode of FIG. 6C, the synchronization signal detector 36 of processor circuitry 30 is configured to ascertain information regarding the timing source depending on whether the received synchronization sequence belongs to the first subset of synchronization sequence or the second subset of synchronization sequences.

It should be noted that, in the lower layer of synchronization sequences of FIG. 6C, the synchronization sequences framed by broken line and having identifiers ID=0 up to the lowest identifier of the third subset are available for use to indicate yet other synchronization-affecting information or parameters, including but not limited to those of other embodiments herein described such as synchronization source and range of vehicle speed.

Service Type Embodiments

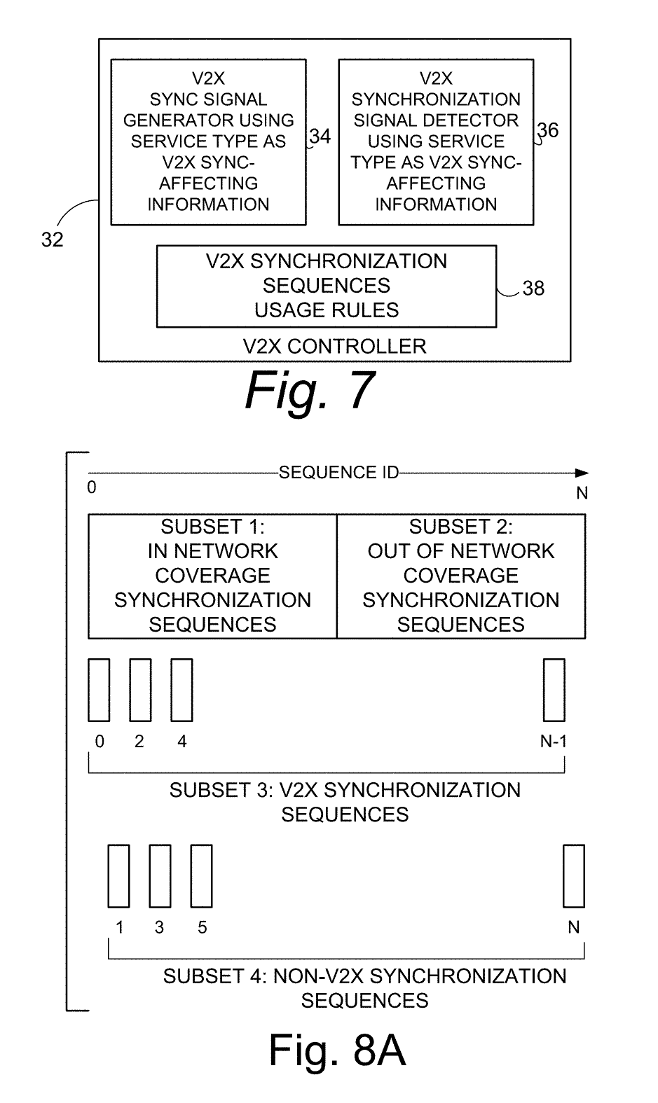

In second embodiments and modes the synchronization-affecting information indicates a service type for the vehicle communications. As illustrated generically in FIG. 7, the synchronization-affecting information indicates a service type used by the wireless terminal 20 for the vehicle (V2X) communication. FIG. 7 shows an example embodiment in which the V2X controller 32 comprises one or both of synchronization signal generator 34 and synchronization signal detector 36 that uses identification of a service type as the synchronization-affecting information.

In the FIG. 7 example embodiments, the set of synchronization sequences available to synchronization signal generator 34 for synchronization signal generation, and to synchronization signal detector 36 for decoding of a received synchronization signal, comprises a first subset comprising synchronization sequences for which timing is derived from a cellular radio access network node; a second subset comprising synchronization sequences for which timing is not derived from the cellular radio access network node; a third subset comprising the subset of synchronization sequences for a V2X communication service type; and, a fourth subset comprising the subset of synchronization sequences for a non-V2X communication service type. The third subset overlaps with one or both of the first and second subsets but does not overlap with the fourth subset.

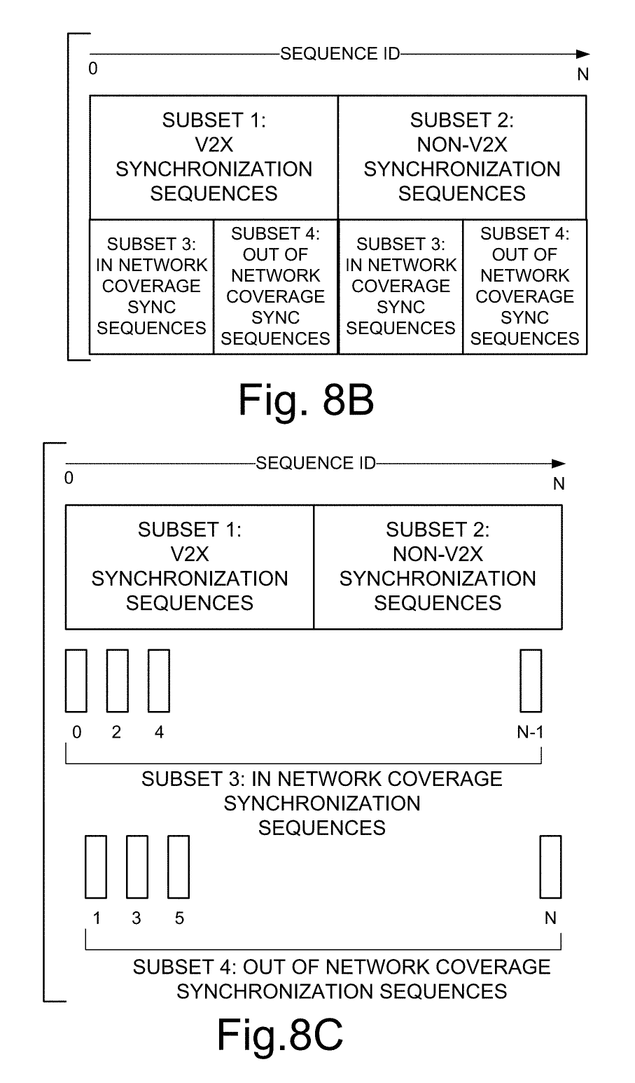

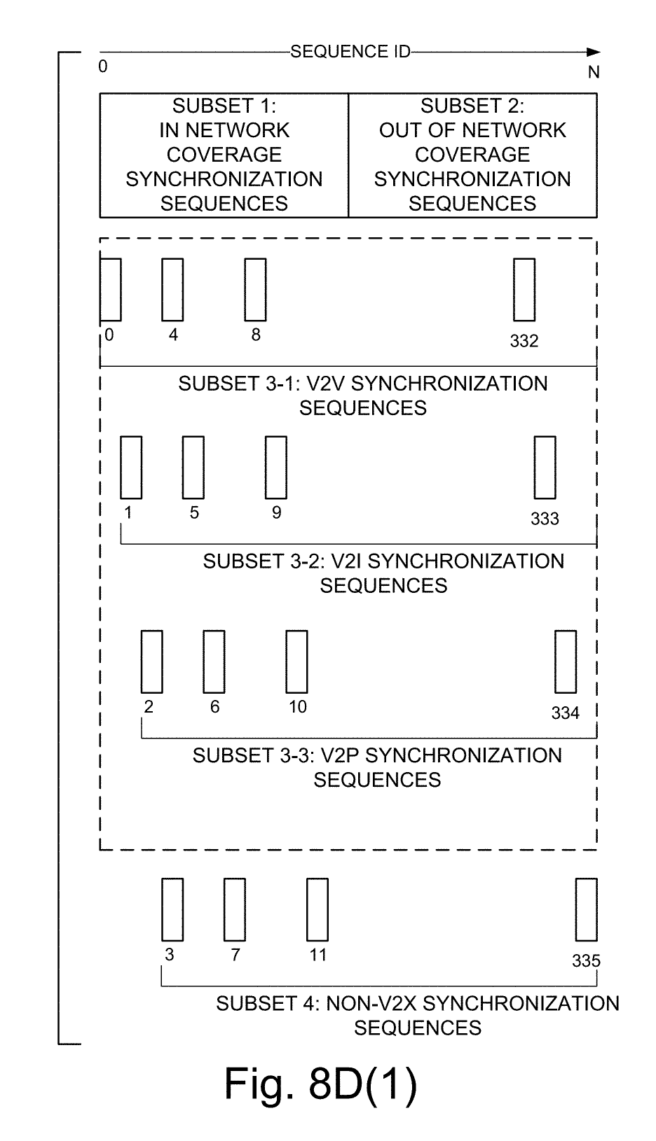

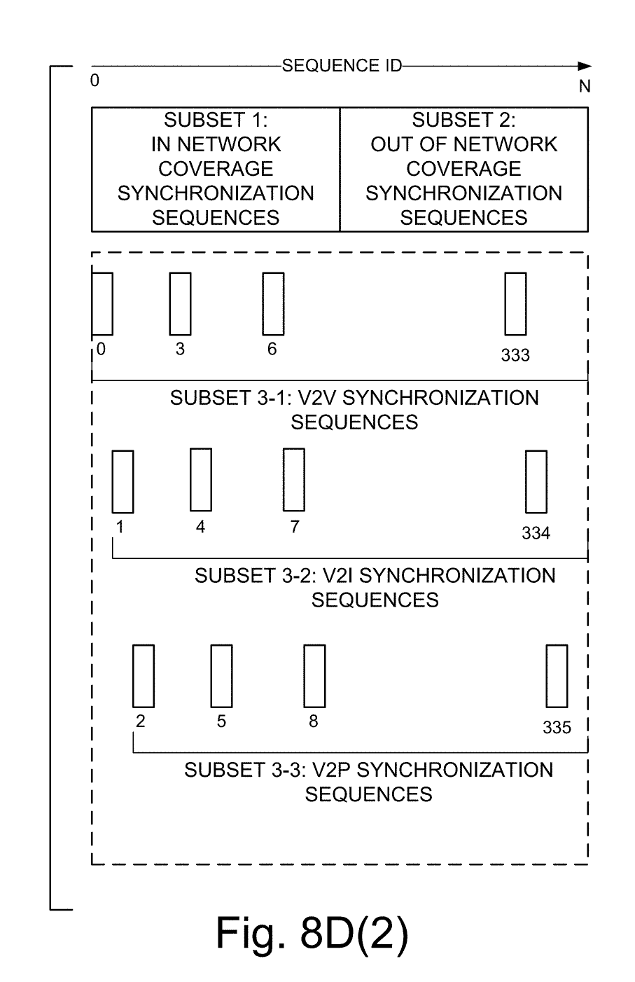

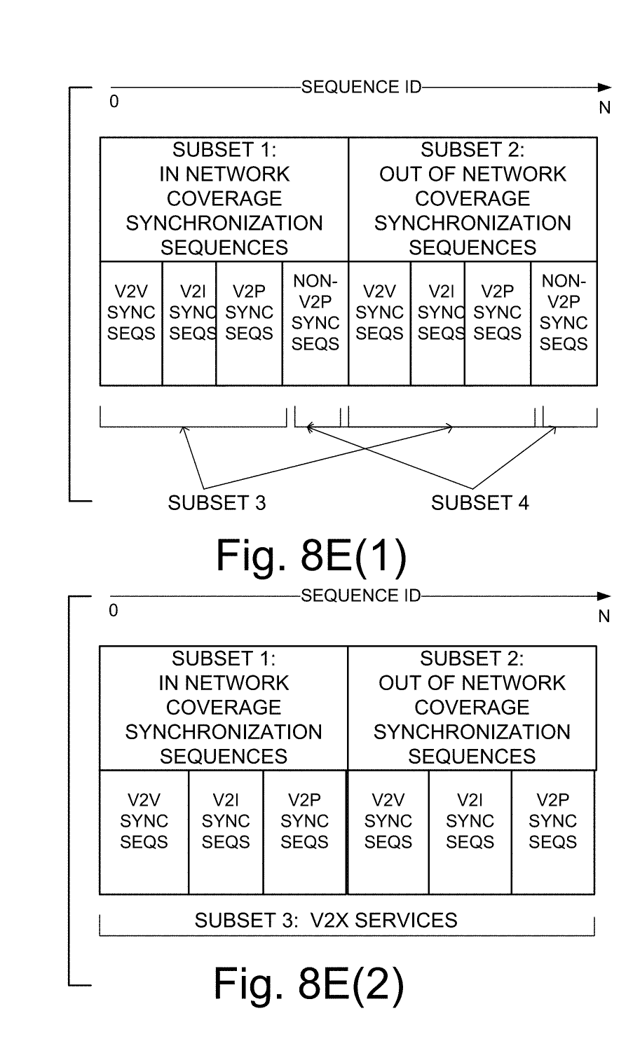

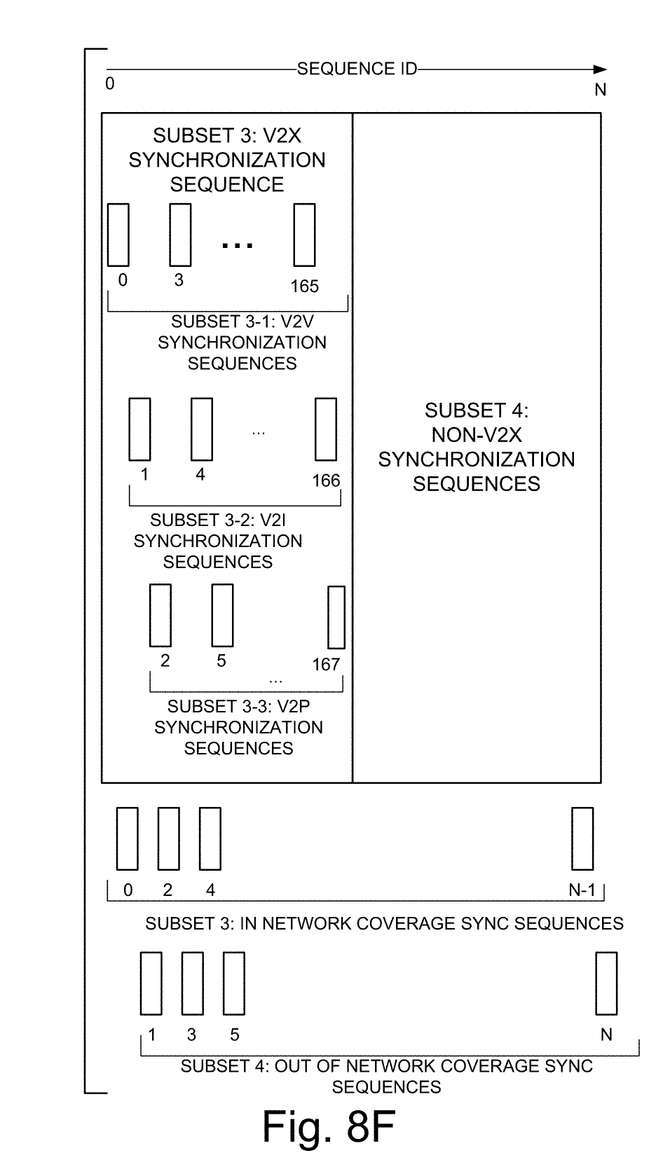

FIG. 8A shows an example implementation of the FIG. 7 example embodiment wherein service type is used as the synchronization-affecting information. Somewhat similar to the FIG. 6A implementation in format, but different in type of synchronization-affecting information. In the FIG. 8A implementation the third subset of synchronization sequences comprises either (1) only odd numbered members of one or both of the first subset of synchronization sequences and the second subset of synchronization sequences or (2) only even numbered members of one or both of the first subset of synchronization sequences and the second subset of synchronization sequences, and the fourth subset of synchronization sequences comprises members of one or both of the first subset of synchronization sequences and second subset of synchronization sequences that do not belong to the third subset of synchronization sequences.

In the example embodiment and mode of FIG. 8A, the synchronization signal generator 34 of processor circuitry 30 is configured to select the selected synchronization sequence as belonging either the first subset of synchronization sequence or the second subset of synchronization sequences; and as belonging either the third subset of synchronization sequences or the fourth subset of synchronization sequences.

In the example embodiment and mode of FIG. 8C, the synchronization signal detector 36 of processor circuitry 30 is configured to ascertain the service type depending on whether the received synchronization sequence belongs to the third subset of synchronization sequences or the fourth subset of synchronization sequences.

The example embodiment and mode of FIG. 8A is essentially compatible to the nature of synchronization sequence construction for sidelink direct (SLD) communications from the vantage point that the first subset comprises synchronization sequences for which timing is derived from a cellular radio access network node and the second subset comprises synchronization sequences for which timing is not derived from the cellular radio access network node, and in which synchronization sequences are generated using the two expressions N_{ID}⁽¹⁾=N_{ID}^{V2X} mod 168[N_{ID}⁽¹⁾ε{0, 1, . . . , 167}, and N_{ID}⁽²⁾=└N_{ID}^{V2X}/168┘[N_{ID}⁽²⁾ε{0, 1}] as described above. In this regard, in FIG. 8A the upper illustrated “layer” of sequences comprised by first subset and second subset is vertically above the illustrated lower layers of the third subset and the fourth subset.

By contrast, the example implementation of FIG. 8C is essentially an inversion of the implementation of FIG. 8A, and thus is not necessarily compatible with the sidelink direct (SLD) protocol, although having other advantages. In the example implementation of FIG. 8C, the subsets available to the V2X controller 32 are: a first subset comprising the subset of synchronization sequences for the V2X communication service type; a second subset comprising the subset of synchronization sequences for a non-V2X communication service type; a third subset of synchronization sequences which comprises synchronization sequences for which timing is derived from a cellular radio access network node; a fourth subset of synchronization sequences which comprises synchronization sequences for which timing is not derived from the cellular radio access network node. Thus, in the implementation of FIG. 8C it is the first subset (the first service type subset) and the second subset (the second service type subset) that in which synchronization sequences are generated using the two expressions N_{ID}⁽¹⁾=N_{ID}^{V2X} mod 168[N_{ID}⁽¹⁾ε{0, 1, . . . , 167}, and N_{ID}⁽²⁾=└N_{ID}^{V2X}/168┘[N_{ID}⁽²⁾ε{0, 1}] as described above. The third subset of synchronization sequences and the fourth subset of synchronization sequences do not overlap.

In the example embodiment and mode of FIG. 8C the third subset of synchronization sequences as comprises either only odd numbered members or only even numbered members of one or both of the first subset of synchronization sequences and the second subset of synchronization sequences. For example, FIG. 8C shows the third subset of synchronization sequences as comprising the synchronization sequences which have even identifiers 0, 2, 4, . . . 334. Conversely the fourth subset of synchronization sequences are illustrated in FIG. 6C as comprising members of one or both of the first subset of synchronization sequences and second subset of synchronization sequences that do not belong to the third subset of synchronization sequences, e.g. synchronization sequences having identifiers 1, 3, 5, . . . 335

FIG. 6B, FIG. 6B illustrate the third subset of synchronization sequences and the fourth subset of synchronization sequences as comprising partitions of the first subset of synchronization sequences and the second subset of synchronization sequences. For example, the third subset of synchronization sequences may comprise synchronization sequences having IDs 0-83 (a first partition of the first subset of synchronization sequences) and synchronization sequences having IDs 168-252 (a first partition of the second subset of synchronization sequences), and the fourth subset of synchronization sequences may comprise synchronization sequences having IDs 84-167 (a second partition of the first subset of synchronization sequences) and synchronization sequences having IDs 253-335 (a second partition of the second subset of synchronization sequences). Other partitioning techniques, or further ways of defining the third subset and fourth subset are also encompassed hereby.

In the example embodiments and modes of FIG. 8B and FIG. 8C, the synchronization signal generator 34 of processor circuitry 30 is configured to selected the selected synchronization sequence as belonging to: (1) either the first subset of synchronization sequence or the second subset of synchronization sequences; and (2) either the third subset of synchronization sequences or the fourth subset of synchronization sequences.

In the example embodiments and modes of FIG. 8B and FIG. 8C, the synchronization signal detector 36 of processor circuitry 30 is configured to ascertain the service type depending on whether the received synchronization sequence belongs to the third subset of synchronization sequences or the fourth subset of synchronization sequences.

The “service type” embodiments thus far described essentially concern two types of service, e.g., a vehicle (V2X) communication service and a non-vehicle (V2X) communication service. In other example embodiments and modes of the technology disclosed herein, one of a greater number (e.g., >2) of service types may be indicated by the choice of synchronization sequence. Such encompasses distinguishing between a parent or umbrella type of service (e.g., vehicle (V2X) communication service) and sub-services, or more specific types of services encompassed under the parent service (e.g., V2V, V2D, V2I). In terms of indicating service types (or sub-service types) numbering more than two, FIG. 8D(1) illustrates yet another example implementation of the service type embodiment and mode in which the synchronization sequences available for use by V2X controller 32 comprise: a first subset comprising synchronization sequences for which timing is derived from a cellular radio access network node; a second subset comprising synchronization sequences for which timing is not derived from the cellular radio access network node; a third subset comprising the subset of synchronization sequences for a V2X communication service type (the third subset in turn comprising plural further subsets respectively corresponding to plural different V2X communication service types, the plural different V2X communication service types comprising at least two of vehicle-to-vehicle (V2V) communication, vehicle-to-pedestrian (V2P) communication, and vehicle-to-infrastructure (V2I) communication); and a fourth subset comprising the subset of V2X synchronization sequences for of synchronization sequences for the non-V2X communication service type.

It can be seen that in the example implementation of FIG. 8D(1), the vehicle (V2X) communication set of sequences, i.e., the V2XSS ID set {0, 2, . . . , 334} and {1, 3, . . . , 335} are further divided into {0, 4, . . . , 332}, {2, 6, . . . , 334}, {1, 5, . . . , 333} and {3, 7, . . . , 335} for V2V service type, V2P service type, V2I service type, and non-V2X service type, respectively. It should be understood that other orderings of the service types are envisioned in other example implementations.

In the example embodiment and mode of FIG. 8D(1), the synchronization signal generator 34 of processor circuitry 30 is configured to selected the selected synchronization sequence as belonging (1) to either the first subset of synchronization sequence or the second subset of synchronization sequences; and (2) to either the third subset of synchronization sequences or the fourth subset of synchronization sequences, and (3) if belong to the third subset of synchronization sequences, then within the third subset as belonging to one of the plural further subsets.

In the example embodiment and mode of FIG. 8D(1), the synchronization signal detector 36 of processor circuitry 30 is configured to ascertain the service type depending on whether the synchronization sequence belongs to: (1) either the third subset of synchronization sequences or the fourth subset of synchronization sequences, and (2) if belonging to the third subset of synchronization sequences, then within the first third as belonging to one of the plural further subsets.

Moreover, there may be a different number of service types, such as three service types as shown in FIG. 8D(2). FIG. 8D(2) particularly shows use of the third subset of synchronization sequences as comprising the three services types V2I, V2P, and V2V, but no use of a fourth subset and hence no other service types. The services types of FIG. 8(D) are also interleaved across the range of synchronization sequence identifiers, with the identifiers for the V2V service type synchronization sequence being illustrated as 0, 3, 6, . . . 333; the identifiers for the V2I service type synchronization sequence being illustrated as 1, 4, 7, . . . 334; and the identifiers for the V2P service type synchronization sequence being illustrated as 2, 5, 8, . . . 335. In the example embodiment and mode of FIG. 8D(2), the synchronization signal generator 34 of processor circuitry 30 is configured to selected the selected synchronization sequence as belonging (1) to either the first subset of synchronization sequence or the second subset of synchronization sequences; and (2) as belonging to one of the plural further subsets of the third subset of synchronization sequences. In the example embodiment and mode of FIG. 8D(2), the synchronization signal detector 36 of processor circuitry 30 is configured to ascertain the service type depending on whether the synchronization sequence belongs to: (1) either the third subset of synchronization sequences or the fourth subset of synchronization sequences, and (2) a particular one of the plural further subsets of the third subset of synchronization sequences.

It should be appreciated that, with the example embodiment of FIG. 8D(2), the first subset and the second subset need not be utilized. In that regard, the set of synchronization sequences may comprise plural subsets respectively corresponding to plural different V2X communication service types, the plural different V2X communication service types comprising at least two of vehicle-to-vehicle (V2V) communication, vehicle-to-pedestrian (V2P) communication, and vehicle-to-infrastructure (V2I) communication. In such example embodiment, the processor circuitry is configured to select the selected synchronization sequence as belonging to one of the plural further subsets.

Not only are other quantities and orderings of the plural service types possible, but also differing distributions of the subsets across the synchronization sequence range (from 0 to N). FIG. 8E(1) illustrates yet another implementation wherein the third subset of synchronization sequences and the fourth subset of synchronization sequences as comprising partitions of the first subset of synchronization sequences and the second subset of synchronization sequences. For example, the V2V synchronization sequences of the third subset of synchronization sequences may comprise synchronization sequences having IDs 0-41 (a first partition of the first subset of synchronization sequences) and synchronization sequences having IDs 168-209 (a first partition of the second subset of synchronization sequences); the V2I synchronization sequences of the third subset of synchronization sequences may comprise synchronization sequences having IDs 42-83 (a second partition of the first subset of synchronization sequences) and synchronization sequences having IDs 210-252 (a second partition of the second subset of synchronization sequences); and the V2D synchronization sequences of the third subset of synchronization sequences may comprise synchronization sequences having IDs 84-125 (a third partition of the first subset of synchronization sequences) and synchronization sequences having IDs 253-291 (a third partition of the second subset of synchronization sequences). The fourth subset may comprise synchronization sequences having IDs 126-167 (a fourth partition of the first subset of synchronization sequences) and synchronization sequences having IDs 292-335 (a fourth partition of the second subset of synchronization sequences). Other orderings of the respective sub-services V2I, V2P, and V2D are also possible.

Moreover, for the FIG. 8E(1) type embodiment there may also be a different number of service types, such as three service types as shown in FIG. 8E(2). FIG. 8E(2) particularly shows use of the third subset of synchronization sequences as comprising the three services types V2I, V2P, and V2V, but no use of a fourth subset and hence no other service types.

For example, the V2V synchronization sequences of the third subset of synchronization sequences of FIG. 8E(2) may comprise synchronization sequences having IDs 0-(N/6-1) (a first partition of the first subset of synchronization sequences) and synchronization sequences having IDs N/2-(2N/3-1) (a first partition of the second subset of synchronization sequences); the V2I synchronization sequences of the third subset of synchronization sequences may comprise synchronization sequences having IDs N/6-(N/3-1) (a second partition of the first subset of synchronization sequences) and synchronization sequences having IDs 2N/3-(5N/6-1) (a second partition of the second subset of synchronization sequences); and the V2D synchronization sequences of the third subset of synchronization sequences may comprise synchronization sequences having IDs N/3-(N/2-1) (a third partition of the first subset of synchronization sequences) and synchronization sequences having IDs 5N/6-335 (a third partition of the second subset of synchronization sequences).

It should be appreciated that, with the example embodiment of FIG. 8E(2), the first subset and the second subset need not be utilized. In that regard, the set of synchronization sequences may comprise plural subsets respectively corresponding to plural different V2X communication service types, the plural different V2X communication service types comprising at least two of vehicle-to-vehicle (V2V) communication, vehicle-to-pedestrian (V2P) communication, and vehicle-to-infrastructure (V2I) communication. In such example embodiment, the processor circuitry is configured to select the selected synchronization sequence as belonging to one of the plural further subsets.

The example embodiments and modes of FIG. 8E(1) and FIG. 8E(2), for example, are essentially compatible to in nature of synchronization sequence construction for sidelink direct (SLD) communications from the vantage point that the first subset comprises synchronization sequences for which timing is derived from a cellular radio access network node and the second subset comprises synchronization sequences for which timing is not derived from the cellular radio access network node, and in which synchronization sequences are generated using the two expressions N_{ID}⁽¹⁾=N_{ID}^{V2X} mod 168[N_{ID}⁽¹⁾ε{0, 1, . . . , 167}, and N_{ID}⁽²⁾=└N_{ID}^{V2X}/168┘[N_{ID}⁽²⁾ε{0, 1}] as described above. In this regard, in FIG. 8E(1) the upper illustrated “layer” of sequences comprised by first subset and second subset is vertically above the illustrated lower layers of the third subset and the fourth subset.

The example implementation of FIG. 8F is essentially an inversion of the implementation of FIG. 8E(1), and thus is not necessarily compatible with the sidelink direct (SLD) protocol, although having other advantages. In the example implementation of FIG. 8F, the subsets available to the V2X controller 32 are:
(1) a first subset a comprising the subset of synchronization sequences for a V2X communication service type, the first subset in turn comprising plural further subsets respectively corresponding to plural different V2X communication service types, the plural different V2X communication service types comprising at least two of vehicle-to-vehicle (V2V) communication, vehicle-to-pedestrian (V2P) communication, and vehicle-to-infrastructure (V2I) communication;
(2) a second subset comprising the subset of V2X synchronization sequences for of synchronization sequences for the non-V2X communication service type;
(3) a third subset of synchronization sequences which is a subset of the second subset of synchronization sequence and which comprises synchronization sequences for which timing is derived from a cellular radio access network node;
(4) a fourth subset of synchronization sequences which is a subset of the second subset of synchronization sequence and which comprises synchronization sequences for which timing is not derived from the cellular radio access network node, wherein the third subset of synchronization sequences and the fourth subset of synchronization sequences do not overlap;

In the example embodiment and mode of FIG. 8F, the synchronization signal generator 34 of processor circuitry 30 is configured to select the selected synchronization sequence as belonging to either the first subset of synchronization sequences or the second subset of synchronization sequences, and if belonging to the first subset of synchronization sequences, then within the first subset as belonging to one of the plural further subsets; and either the third subset of synchronization sequences or the fourth subset of synchronization sequences.

In the example embodiment and mode of FIG. 8F, the synchronization signal detector 36 of processor circuitry 30 is configured to ascertain the service type depending on whether the received synchronization sequence belongs to: either the first subset of synchronization sequences or the second subset of synchronization sequences; and if belonging to the first subset of synchronization sequences, then ascertaining to which of the plural further subsets the received synchronization sequence belongs.

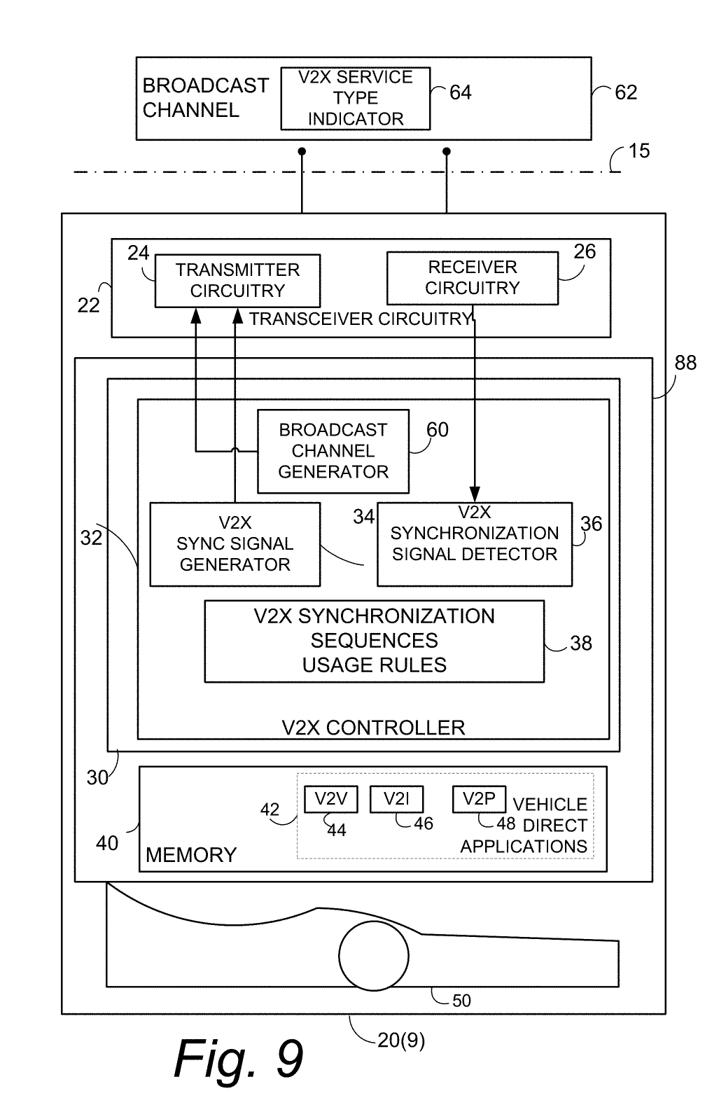

FIG. 9 is a schematic view of a wireless terminal 20(9) according to an example embodiment that includes an identification of a service type in a broadcast channel, rather than as synchronization-affecting information included in or ascertained from a synchronization sequence. In addition to the constituent elements and functionalities shown and described with reference to FIG. 3, wireless terminal 20(9) of FIG. 9 includes broadcast channel generator 60. The broadcast channel generator 60 serves to include an indication of service type in a broadcast channel utilized by the vehicle (V2X) communication. FIG. 9 further diagrammatically depicts such a broadcast channel 62 as including an information element or field 64 in which a value indicative of the service type is included. For example, the information element or field 64 may be a one bit field which indicates by value 0 that a vehicle (V2X) communication service is involved, and by a value 1 that a non-vehicle (V2X) communication service is involved. A larger field may be provided in a situation in which there are more than two services types, e.g., V2I, V2V, and V2P. The broadcast channel 62 may be included in a subframe of information transmitted over the vehicle (V2X) communication radio interface 15.

Speed Range Embodiments

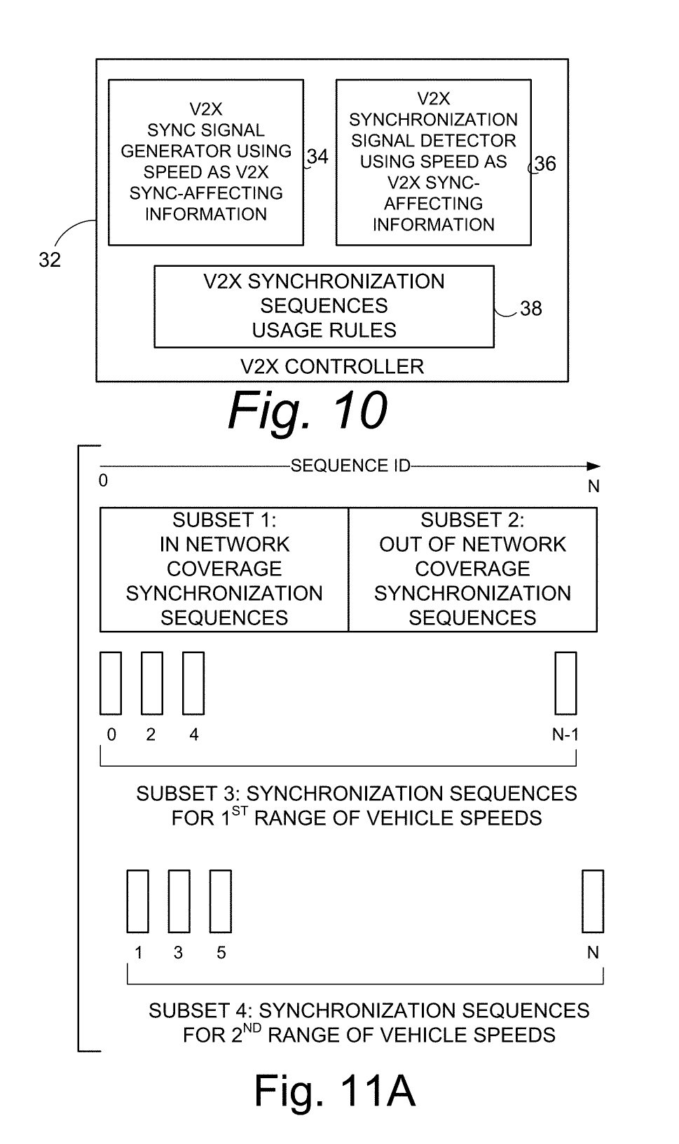

For third example embodiments and modes the synchronization-affecting information indicates a range of speed or velocity for the wireless terminal 20 that serves as a synchronization source for vehicle (V2X) communication. FIG. 10 generically shows an example embodiment in which the V2X controller 32 comprises one or both of synchronization signal generator 34 and synchronization signal detector 36 that uses identification of a range of speed or velocity for the wireless terminal 20 that serves as a synchronization source as the synchronization-affecting information. In the FIG. 10 example embodiments, the set of synchronization sequences available to synchronization signal generator 34 for synchronization signal generation, and to synchronization signal detector 36 for decoding of a received synchronization signal, comprises a subset of synchronization sequences for a vehicle first speed range and a subset of synchronization sequences for a vehicle second speed range.

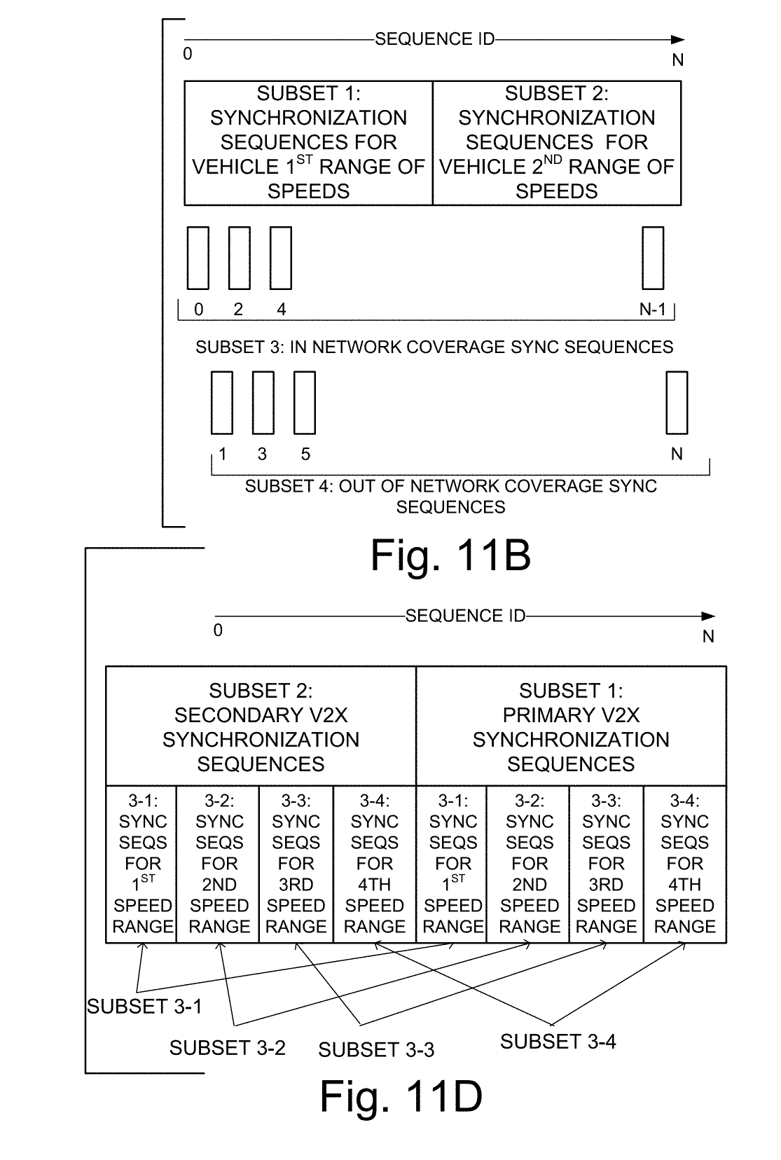

FIG. 11A shows an example implementation of the range of speed embodiments in which the set of synchronization sequences comprises: a first subset comprising synchronization sequences for which timing is derived from a cellular radio access network node; a second subset comprising synchronization sequences for which timing is not derived from the cellular radio access network node; a third subset comprising the subset of synchronization sequences for the vehicle first speed range; and, a fourth subset comprising the subset of synchronization sequences for the vehicle second speed range. As shown in FIG. 11A, the third subset overlaps with one or both of the first and second subsets; the fourth subset overlaps with one or both of the first and second subsets; and, the third subset and the fourth subset do not overlap. In the particular implementation shown in FIG. 11A, the third subset of synchronization sequences comprises either (1) only odd numbered members of one or both of the first subset of synchronization sequences and the second subset of synchronization sequences, or (2) only even numbered members of one or both of the first subset of synchronization sequences and the second subset of synchronization sequences. Moreover, the fourth subset of synchronization sequences comprises members of one or both of the first subset of synchronization sequences and second subset of synchronization sequences that do not belong to the third subset of synchronization sequences.

In the example embodiment and mode of FIG. 11A, the synchronization signal generator 34 of processor circuitry 30 is configured to select the selected synchronization sequence as belonging to (1) either the first subset of synchronization sequence or the second subset of synchronization sequences; and (2) either the third subset of synchronization sequences or the fourth subset of synchronization sequences.

In the example embodiment and mode of FIG. 11A, the synchronization signal detector 36 of processor circuitry 30 is configured to ascertain the range of vehicle speed depending on whether the received synchronization sequence belongs to either the third subset of synchronization sequences or the fourth subset of synchronization sequences.

The example embodiment and mode of FIG. 11A is essentially compatible to the nature of synchronization sequence construction for sidelink direct (SLD) communications from the vantage point that the first subset comprises synchronization sequences for which timing is derived from a cellular radio access network node and the second subset comprises synchronization sequences for which timing is not derived from the cellular radio access network node, and in which synchronization sequences are generated using the two expressions N_{ID}⁽¹⁾=N_{ID}^{V2X} mod 168[N_{ID}⁽¹⁾ε{0, 1, . . . , 167}, and N_{ID}⁽²⁾=└N_{ID}^{V2X}/168┘[N_{ID}⁽²⁾ε{0, 1}] as described above. In this regard, in FIG. 11A the upper illustrated “layer” of sequences comprised by first subset and second subset is vertically above the illustrated lower layers of the third subset and the fourth subset.

By contrast, the example implementation of FIG. 11B is essentially an inversion of the implementation of FIG. 11A, and thus is not necessarily compatible with the sidelink direct (SLD) protocol, although having other advantages. In the example implementation of FIG. 11B, the subsets available to the V2X controller 32 are: a first subset comprising subset of synchronization sequences for the vehicle first speed range; a second subset comprising subset of synchronization sequences for the vehicle second speed range; a third subset of synchronization sequences which comprises synchronization sequences for which timing is derived from a cellular radio access network node; and, a fourth subset of synchronization sequences which comprises synchronization sequences for which timing is not derived from the cellular radio access network node. The third subset of synchronization sequences and the fourth subset of synchronization sequences do not overlap. Thus, in the implementation of FIG. 11B it is the first subset (the first service type subset) and the second subset (the second service type subset) that in which synchronization sequences are generated using the two expressions N_{ID}⁽¹⁾=N_{ID}^{V2X} mod 168[N_{ID}⁽¹⁾ε{0, 1, . . . , 167}, and N_{ID}⁽²⁾=└N_{ID}^{V2X}/168┘[N_{ID}⁽²⁾ε{0, 1}] as described above.

In the embodiment and mode of FIG. 11B, the synchronization signal generator 34 of synchronization controller 32 is configured to select the selected synchronization sequence as belonging to: (1) either the first subset of synchronization sequence or the second subset of synchronization sequences; and (2) either the third subset of synchronization sequences or the fourth subset of synchronization sequences.

In the embodiment and mode of FIG. 11B, the synchronization signal detector 36 of synchronization controller 32 is configured to ascertain the range of vehicle speed depending on whether the received synchronization sequence belongs to the first subset of synchronization sequence or the second subset of synchronization sequences.

The “range of speed” embodiments thus far described essentially concern two ranges of speed. In other example embodiments and modes of the technology disclosed herein, one of a greater number (e.g., >2) of ranges of vehicle speed may be indicated by the choice of synchronization sequence, e.g., a static speed, a low speed, a medium speed, and high speed.

In terms of indicating vehicle speed ranges numbering more than two, FIG. 11C illustrates yet another example implementation of the service type embodiment and mode in which the synchronization sequences available for use by V2X controller 32 comprise: a first subset comprising synchronization sequences for which timing is derived from a cellular radio access network node; a second subset comprising synchronization sequences for which timing is not derived from the cellular radio access network node; a third subset comprising the subset of synchronization sequences reflecting vehicle speed (the third subset in turn comprising plural further subsets respectively corresponding to plural different ranges of vehicle speed, e.g., four different ranges of vehicle speed. As can be seen that in the example implementation of FIG. 11C, the vehicle (V2X) communication set of sequences, i.e., the V2XSS ID set {0, 2, . . . , 334} and {1, 3, . . . , 335} are further divided into {0, 4, . . . , 332}, {2, 6, . . . , 334}, {1, 5, . . . , 333} and {3, 7, . . . , 335} for the first speed range, the second speed range, the third speed range, and the fourth speed range, respectively. It should be understood that other orderings of the service types are envisioned in other example implementations.

In the example embodiment and mode of FIG. 11C, the synchronization signal generator 34 of processor circuitry 30 is configured to selected the selected synchronization sequence as belonging (1) to either the first subset of synchronization sequence or the second subset of synchronization sequences; and (2) to either the third subset of synchronization sequences or the fourth subset of synchronization sequences, and (3) if belong to the third subset of synchronization sequences, then within the third subset as belonging to one of the plural further subsets.

In the example embodiment and mode of FIG. 11C, the synchronization signal detector 36 of processor circuitry 30 is configured to ascertain the service type depending on whether the synchronization sequence belongs to: (1) either the third subset of synchronization sequences or the fourth subset of synchronization sequences, and (2) if belonging to the third subset of synchronization sequences, then within the first third as belonging to one of the plural further subsets.

Not only are other orderings of the plural service types possible, but also differing distributions of the subsets across the synchronization sequence range (from 0 to N). FIG. 11D illustrates yet another implementation wherein the third subset of synchronization sequences and the fourth subset of synchronization sequences as comprising partitions of the first subset of synchronization sequences and the second subset of synchronization sequences. For example, the synchronization sequences of the first speed range of the third subset of synchronization sequences may comprise synchronization sequences having IDs 0-41 (a first partition of the first subset of synchronization sequences) and synchronization sequences having IDs 168-209 (a first partition of the second subset of synchronization sequences); the synchronization sequences of the second speed range of the third subset of synchronization sequences may comprise synchronization sequences having IDs 42-83 (a second partition of the first subset of synchronization sequences) and synchronization sequences having IDs 210-252 (a second partition of the second subset of synchronization sequences); the V2D synchronization sequences of the third speed range of the third subset of synchronization sequences may comprise synchronization sequences having IDs 84-125 (a third partition of the first subset of synchronization sequences) and synchronization sequences having IDs 253-291 (a third partition of the second subset of synchronization sequences); and the synchronization sequences of the fourth speed range of the third subset may comprise synchronization sequences having IDs 126-167 (a fourth partition of the first subset of synchronization sequences) and synchronization sequences having IDs 292-335 (a fourth partition of the second subset of synchronization sequences). Other orderings of the respective sub-services V2I, V2P, and V2D are also possible.

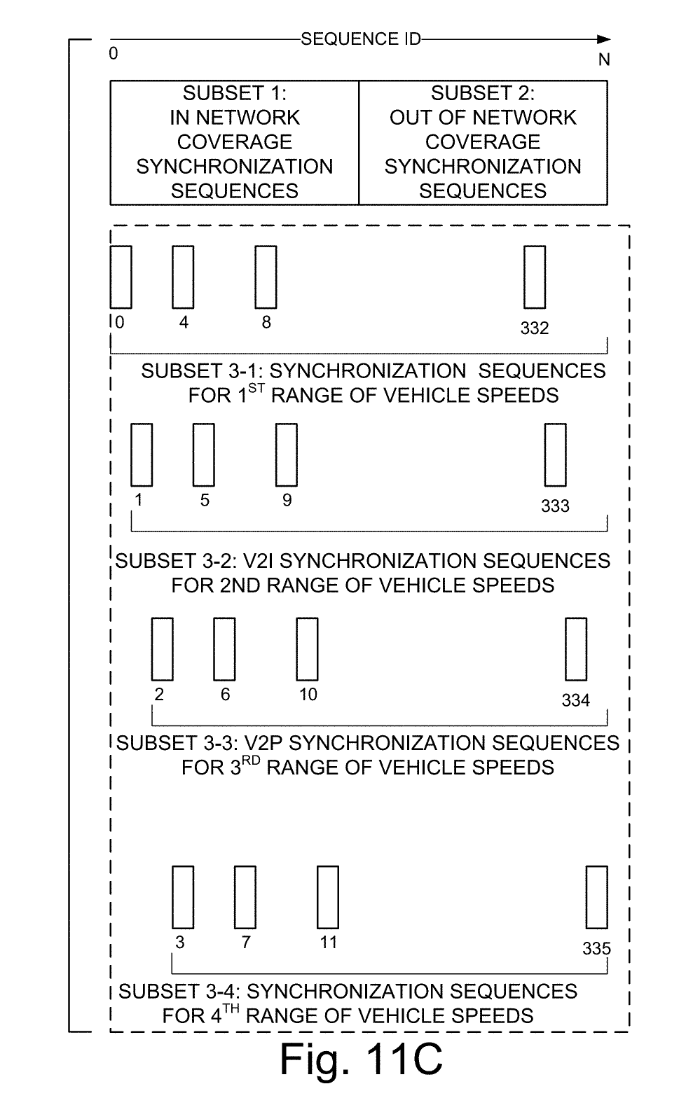

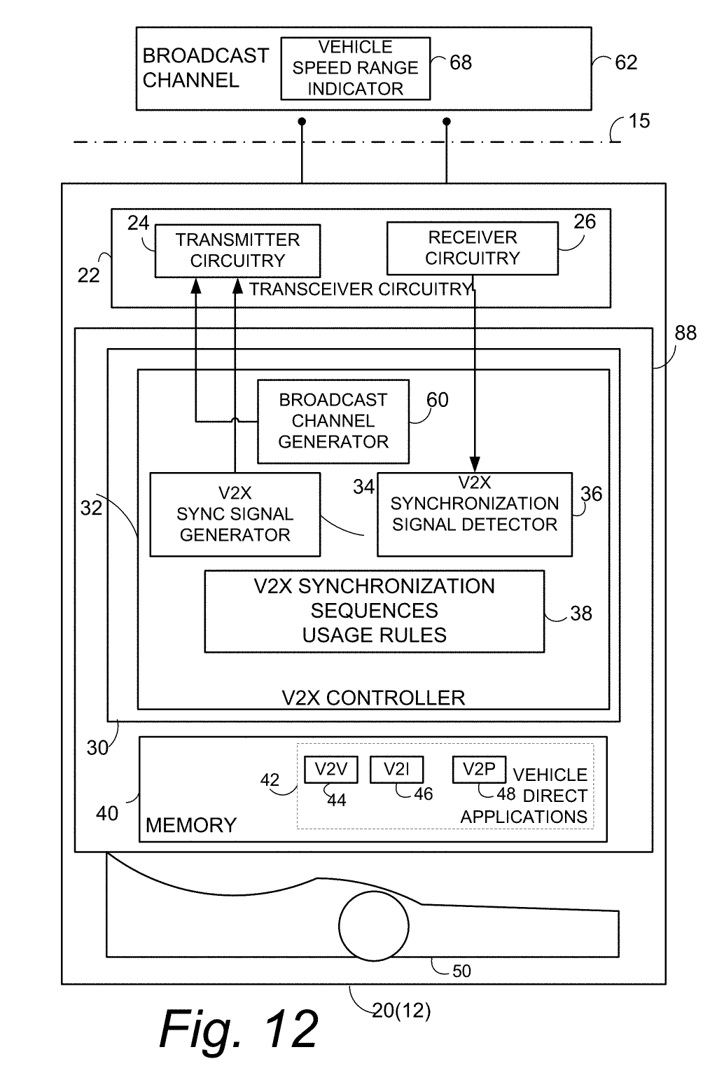

FIG. 12 is a schematic view of a wireless terminal 20(12) according to an example embodiment that includes an identification of a service type in a broadcast channel, rather than as synchronization-affecting information included in or ascertained from a synchronization sequence. In addition to the constituent elements and functionalities shown and described with reference to FIG. 3, wireless terminal 20(12) of FIG. 9 includes broadcast channel generator 60. The broadcast channel generator 60 serves to include an indication of vehicle speed range in a broadcast channel utilized by the vehicle (V2X) communication. FIG. 12 further diagrammatically depicts such a broadcast channel 62 as including an information element or field 66 that carries the indication of vehicle speed range. For example, the information element or field 66 may be a one bit field which indicates by value 0 that the vehicle is traveling at in a first speed range, and by a value 1 that the vehicle is traveling at in a second speed range. Larger fields can be formatted in situations in which the indication is from one of more than two speed ranges. The broadcast channel 62 may be included in a subframe of information transmitted over the vehicle (V2X) communication radio interface 15.

Plural Parameter Embodiments

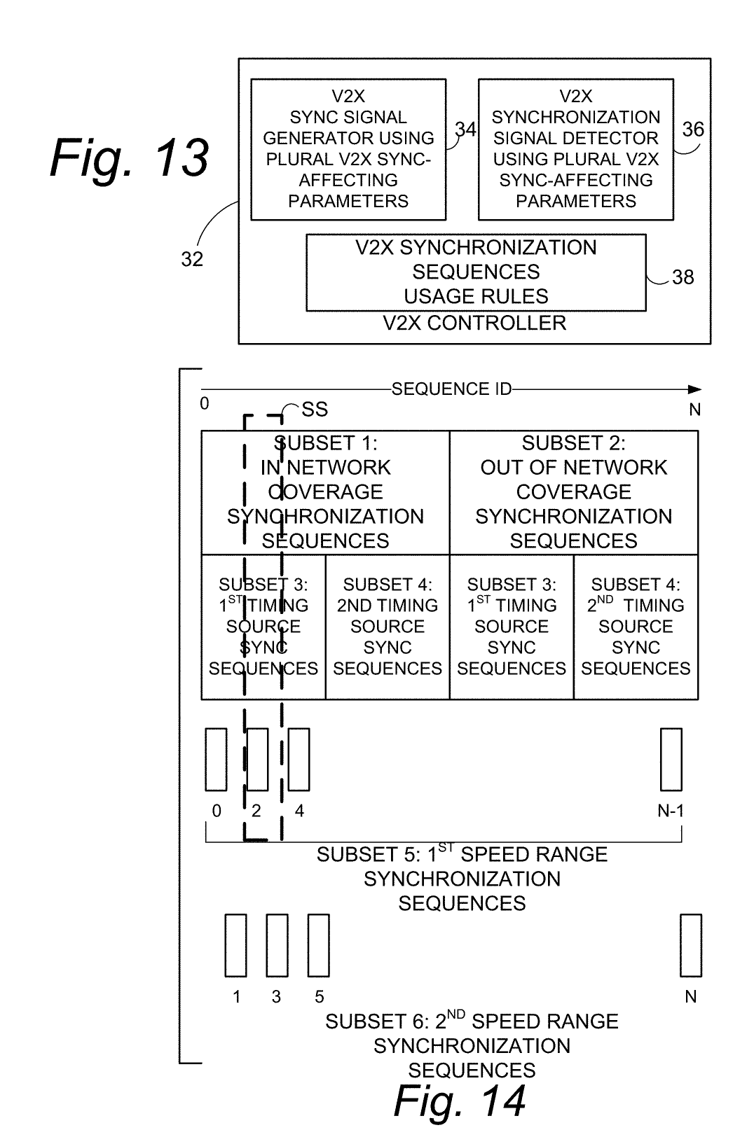

As seen above, in differing example embodiments and modes the selection of selected synchronization sequence is dependent upon a synchronization-affecting information or a synchronization-affecting parameters used for the V2X communication. In other example embodiments and modes the selection of selected synchronization sequence is dependent upon plural types of synchronization-affecting information or plural synchronization-affecting parameters used for the V2X communication. For example, FIG. 13 and FIG. 14 show an example embodiment in which the V2X controller 32 comprises one or both of synchronization signal generator 34 and synchronization signal detector 36 that uses plural types of synchronization-affecting parameters used for the V2X communication.

FIG. 14 shows an example which the set of synchronization sequences available to V2X controller 32 and thus defined in V2X synchronization sequence usage rules 38 comprises: (1) a first subset comprising synchronization sequences for which timing is derived from a cellular radio access network node; (2) a second subset comprising synchronization sequences for which timing is not derived from the cellular radio access network node; (3) a third subset comprising the V2X synchronization sequences for which timing for the V2X communication is obtained with respect to the first timing source; (4) a fourth subset comprising the V2X synchronization sequences for which timing for the V2X communication is obtained with respect to the second timing source; (5) a fifth subset comprising the subset of synchronization sequences for the vehicle first speed range; and, (6) a sixth subset comprising the subset of synchronization sequences for the vehicle second speed range. As illustrated in FIG. 6A, the third subset overlaps with one or both of the first and second subsets but does not overlap with the fourth subset. In the illustration of FIG. 14, the selected synchronization sequence is a member of each of the first subset, the third subset, and the fifth subset. As such, the selected synchronization sequence informs of three parameters: that the synchronization signal is for in coverage (e.g., in network) [from the first subset]; that the timing source is the first timing source [from the third subset]; and that the vehicle speed is in the first rage of vehicle speeds [from the fifth subset].

Variations of the FIG. 14 use of parameters and subsets are also encompassed hereby. As a first example of the foregoing, in one plural parameter embodiment and mode the plural synchronization-affecting parameters comprise timing source used for the V2X communication and service type, and the processor circuitry is configured to make the selection of selected synchronization sequence dependent upon the timing source used for the V2X communication and the service type of the communication.

In another plural parameter embodiment and mode example the plural synchronization-affecting parameters comprise service type and speed of a vehicle participating in the V2X communication, and the processor circuitry is configured to make the selection of selected synchronization sequence dependent upon the service type of the communication and the speed of the vehicle participating in the V2X communication.

In yet another plural parameter embodiment and mode example the plural synchronization-affecting parameters comprise timing source used for the V2X communication, service type, and speed of a vehicle participating in the V2X communication, and the processor circuitry is configured to make the selection of selected synchronization sequence dependent upon timing source used for the V2X communication, the service type of the communication, and the speed of the vehicle participating in the V2X communication.

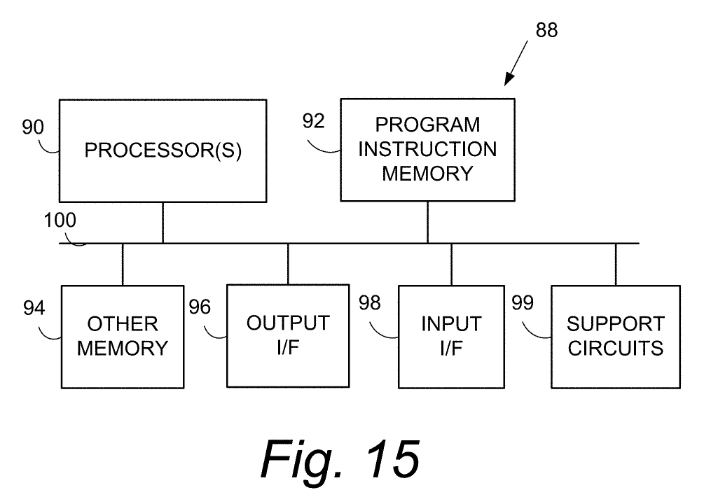

Certain units and functionalities of wireless terminal 20 as illustrated in FIG. 3 and elsewhere framed by broken line are, in an example embodiment, implemented by terminal electronic machinery 88. FIG. 15 shows an example of such electronic machinery 88 as comprising one or more processors 90, program instruction memory 92; other memory 94 (e.g., RAM, cache, etc.); input/output interfaces 96; peripheral interfaces 98; support circuits 99; and busses 100 for communication between the aforementioned units. The processor(s) 90 may comprise the processor circuitry 42, for example.

The memory 94, or computer-readable medium, may be one or more of readily available memory such as random access memory (RAM), read only memory (ROM), floppy disk, hard disk, flash memory or any other form of digital storage, local or remote, and is preferably of non-volatile nature, as and such may comprise memory 40 shown in FIG. 3. The support circuits 99 are coupled to the processors 90 for supporting the processor in a conventional manner. These circuits include cache, power supplies, clock circuits, input/output circuitry and subsystems, and the like.

Although the processes and methods of the disclosed embodiments may be discussed as being implemented as a software routine, some of the method steps that are disclosed therein may be performed in hardware as well as by a processor running software. As such, the embodiments may be implemented in software as executed upon a computer system, in hardware as an application specific integrated circuit or other type of hardware implementation, or a combination of software and hardware. The software routines of the disclosed embodiments are capable of being executed on any computer operating system, and is capable of being performed using any CPU architecture.

The functions of the various elements including functional blocks, including but not limited to those labeled or described as “computer”, “processor” or “controller”, may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented, and thus machine-implemented.

In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) [ASIC], and/or field programmable gate array(s) (FPGA(s)), and (where appropriate) state machines capable of performing such functions.

In terms of computer implementation, a computer is generally understood to comprise one or more processors or one or more controllers, and the terms computer and processor and controller may be employed interchangeably herein. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” may also be construed to refer to other hardware capable of performing such functions and/or executing software, such as the example hardware recited above.

Nodes that communicate using the air interface also have suitable radio communications circuitry. Moreover, the technology disclosed herein may additionally be considered to be embodied entirely within any form of computer-readable memory, such as solid-state memory, magnetic disk, or optical disk containing an appropriate set of computer instructions that would cause a processor to carry out the techniques described herein.

Moreover, each functional block or various features of the wireless terminal 40 used in each of the aforementioned embodiments may be implemented or executed by circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

It will be appreciated that the technology disclosed herein is directed to solving radio communications-centric issues and is necessarily rooted in computer technology and overcomes problems specifically arising in radio communications.

Thus, the technology disclosed herein concerns and comprises the following implementations:

GNSS Only is Considered in Synchronization Signal Design.

Alt a.1): Compatiable with D2D Design
Same as sidelink design for D2D: N_{ID}^{V2X}ε{0, 1, . . . , 335}, divided into two sets id_net and id_oon consisting of identities {0, 1, . . . , 167} and {168, 169, . . . , 335}, respectively. N_{ID}⁽¹⁾=N_{ID}^{V2X} mod 168, so N_{ID}⁽¹⁾ε{0, 1, . . . , 167}, and N_{ID}⁽²⁾=└N_{ID}^{V2X}/168┘ so N_{ID}⁽²⁾ε{0, 1}, and N_{ID}^{V2X}=N_{ID}⁽²⁾*168+N_{ID}⁽¹⁾, where N_{ID}^{V2X} represents the V2X synchronization sequence (V2XSS) ID; N_{ID}⁽²⁾ represents the V2X primary synchronization sequence (PSS) ID; and N_{ID}⁽¹⁾ represents the V2X secondary synchronization sequence (SSS) ID.
Further, the same V2XSS sequences also divided into two sets id_GNSS and id_nonGNSS, consisting of identities {0, 2, . . . , 334} and {1, 3, . . . , 335}, respectively. So when a V2X UE receives V2XSS with ID 2, it can read the timing information as “this timing is from in coverage GNSS source”; or if the received V2XSS with ID 169, it means the timing is from out of coverage nonGNSS resource. Of course, {0, 2, . . . , 334} corresponds to id_nonGNSS and {1, 3, . . . , 335} corresponds to id_GNSS is also okay.

Alt a.2): Not Compatiable with D2D Design
Same as sidelink design for D2D: N_{ID}^{V2X}ε{0, 1, . . . , 335}, divided into two sets id_GNSS and id_nonGNSS consisting of identities {0, 1, . . . , 167} and {168, 169, . . . , 335}, respectively. N_{ID}⁽¹⁾=N_{ID}^{V2X} mod 168, so N_{ID}⁽¹⁾ε{0, 1, . . . , 167}, and N_{ID}⁽²⁾=└N_{ID}^{V2X}/168┘ so N_{ID}⁽²⁾ε{0, 1}, and N_{ID}^{V2X}=N_{ID}⁽²⁾*168+N_{ID}⁽¹⁾, where N_{ID}^{V2X} represents the V2X synchronization sequence (V2XSS) ID; N_{ID}⁽²⁾ represents the V2X primary synchronization sequence (PSS) ID; and N_{ID}⁽¹⁾ represents the V2X secondary synchronization sequence (SSS) ID. Then id_nonGNSS can be further divided into two sets id_nonGNSS_net and id_nonGNSS_oon, whose ID could be {168, 169, . . . , 251} and {252, 253, . . . , 335}, or {252, 253, . . . , 335} and {168, 169, . . . , 251} respectively.

Service Type Only is Considered in Synchronization Signal Design.
In this scenario, the GNSS priority for synchronization source selection is totally the same with some eNB based timing; in other words, from reception UE side, there is no need to distinguish the timing is from GNSS or eNB.

Scenario (b.a):
Only V2X and non-V2X (e.g., D2D) should be distinguished.
Then Alt (b.a.1) and Alt (b.a.2) correspond to Alt (a.1) and Alt (a.2) respectively. The only difference will be replace GNSS with V2X service type, e.g., id_V2X and id_nonV2X.

Scenario (b.b):
V2V, V2P, V2I and non-V2X (e.g., D2D) should be distinguished.

Alt (b.b.1):
similar as Alt (b.a.1), the difference is the V2XSS ID set {0, 2, . . . , 334} and {1, 3, . . . , 335} are further divided into {0, 4, . . . , 332}, {1, 5, . . . , 333} and {3, 7, . . . , 335} for V2V, V2P, V2I and non-V2X respectively (not exactly this order, other order should also be okay)

Alt (b.b.2):
similar as Alt (b.a.2),

Alt (b.b.3):
Two bits in PSBCH (Note: PSBCH is the name for sidelink D2D, here it is similar sidelink broadcast channel for V2X) to represent V2V, V2P, V2I and non-V2X.

Speed Only is Considered in Synchronization Signal Design.
It is impossible to indicate the exact speed number in the signal. But the speed can be categorized into different speed zone.
If there are two speed zones: high speed and low speed. Then the design method is the same as Alt a.1) and Alt a.2), or we can also use 1 bit in PSBCH to indicate this information.
If there are four speed zones: static, low speed, medium speed and high speed. Then the method of 4 service type can be reused here.
If there are three speed zones: low speed, medium speed and high speed, or static, low speed and high speed. Then the difference from two speed zone is one set could be kept and the other set can be divided into two sets, where, the one set kept undivided is the set which correspond to the most common V2X speed, e.g., medium speed if it is low, medium and high; or low speed if it is static, low and high. Or this can be even applicable to different regions, e.g., in rural area freeway, high speed is the most common speed for vehicle.
In the following, I list the scenarios which may use the combination of above for design.

Both GNSS and Service Type are Considered in Synchronization Signal Design

Both GNSS and Speed Type are Considered in Synchronization Signal Design

Both Service and Speed Type are Considered in Synchronization Signal Design

Thus, the technology disclosed herein concerns and comprises one or more of the following non-exhaustive example embodiments and modes:

In an example embodiment and mode the technology disclosed herein concern a user equipment (UE) comprising control circuitry and transmission circuitry. The control circuitry may be configured to select one sidelink synchronization signal (SLSS) sequence from multiple SLSS sequences. The transmission circuitry may be configured to transmit SLSS which is generated by using the selected SLSS sequence. The multiple SLSS sequences may consist of a first subset and a second subset, the first subset being for in-network-coverage, the second subset being for out-of-network-coverage. The first subset may include a third subset, the third subset corresponding to Global Navigation Satellite System (GNSS) timing.

In an example embodiment and mode the technology disclosed herein concern a method for a user equipment (UE). The method may comprise selecting one sidelink synchronization signal (SLSS) sequence from multiple SLSS sequences. The method may also comprise transmitting SLSS which is generated by using the selected SLSS sequence. The multiple SLSS sequences may consist of a first subset and a second subset, the first subset being for in-network-coverage, the second subset being for out-of-network-coverage. The first subset may include a third subset, the third subset corresponding to Global Navigation Satellite System (GNSS) timing.

In an example embodiment and mode the technology disclosed herein concern a wireless terminal comprises processor circuitry and a transmitter. The processor circuitry is configured prepare content for a synchronization signal for a wireless vehicle direct (V2X) communications by making a selection of a selected synchronization sequence from a set of synchronization sequences, the selection being dependent upon synchronization-affecting information used for the V2X communication. The transmitter is configured to transmit the synchronization signal comprising the selected synchronization sequence over a radio interface.

In an example embodiment and mode the selection is dependent upon plural synchronization-affecting parameters used for the V2X communication.

In an example embodiment and mode the plural synchronization-affecting parameters comprise timing source used for the V2X communication and service type, and wherein the processor circuitry is configured to make the selection of selected synchronization sequence dependent upon the timing source used for the V2X communication and the service type of the communication.

In an example embodiment and mode the plural synchronization-affecting parameters comprise service type and speed of a vehicle participating in the V2X communication, and the processor circuitry is configured to make the selection of selected synchronization sequence dependent upon the service type of the communication and the speed of the vehicle participating in the V2X communication.

In an example embodiment and mode the plural synchronization-affecting parameters comprise timing source used for the V2X communication, service type, and speed of a vehicle participating in the V2X communication, and the processor circuitry is configured to make the selection of selected synchronization sequence dependent upon timing source used for the V2X communication, the service type of the communication, and the speed of the vehicle participating in the V2X communication.

In an example embodiment and mode the processor circuitry is configured to make the selection of selected synchronization sequence by selecting the selected synchronization sequence from one of plural subsets of synchronization sequences in dependence upon a value of the synchronization-affecting information.

In an example embodiment and mode the synchronization-affecting information is a timing source used for the V2X communication, and the processor circuitry is configured to make the selection of selected synchronization sequence dependent upon the timing source used for the V2X communication.

In an example embodiment and mode the set of synchronization sequences comprises:

a subset of V2X synchronization sequences for which timing for the V2X communication is obtained with respect to a first timing source;

a subset of V2X synchronization sequences for which timing for the V2X communication is obtained with respect to a second timing source; and

the processor circuitry is configured to select the selected synchronization sequence from one of (1) and (2).

In an example embodiment and mode the first timing source is a source is a timing source available throughout a cellular radio access network but maintained external to the cellular radio access network and the second timing source is maintained by the cellular radio access network.

In an example embodiment and mode the first timing source is a Global Navigation Satellite System (GNSS) timing source.

In an example embodiment and mode the set of synchronization sequences comprises:

a first subset comprising synchronization sequences for which timing is derived from a cellular radio access network node;

a second subset comprising synchronization sequences for which timing is not derived from the cellular radio access network node;

a third subset comprising the V2X synchronization sequences for which timing for the V2X communication is obtained with respect to the first timing source;

a fourth subset comprising the V2X synchronization sequences for which timing for the V2X communication is obtained with respect to the second timing source;

wherein the third subset overlaps with one or both of the first and second subsets but does not overlap with the fourth subset; and

the processor circuitry is configured to selected the selected synchronization sequence as belonging to:

either the first subset of synchronization sequence or the second subset of synchronization sequences; and

either the third subset of synchronization sequences or the fourth subset of synchronization sequences.

In an example embodiment and mode the third subset of synchronization sequences comprises either only odd numbered members or only even numbered members of one or both of the first subset of synchronization sequences and the second subset of synchronization sequences; and the fourth subset of synchronization sequences comprises members of one or both of the first subset of synchronization sequences and second subset of synchronization sequences that do not belong to the third subset of synchronization sequences.

In an example embodiment and mode the set of synchronization sequences comprises:

a first subset comprising the V2X synchronization sequences for which timing for the V2X communication is obtained with respect to the first timing source;

a second subset comprising the V2X synchronization sequences for which timing for the V2X communication is obtained with respect to the second timing source;

a third subset of synchronization sequences which is a subset of the second subset of synchronization sequence and which comprises synchronization sequences for which timing is derived from a cellular radio access network node;

a fourth subset of synchronization sequences which is a subset of the second subset of synchronization sequence and which comprises synchronization sequences for which timing is not derived from the cellular radio access network node. The third subset of synchronization sequences and the fourth subset of synchronization sequences do not overlap. The processor circuitry is configured to select the selected synchronization sequence as belonging to either:

the first subset of synchronization sequence; or

the second subset of synchronization sequences and one but not both of
(b1) the third subset of synchronization sequences; and
(b2) the fourth subset of synchronization sequences.

In an example embodiment and mode the synchronization-affecting information is service type, a first service type being V2X communication and a second service type being non-V2X communication, and the processor circuitry is configured to make the selection of selected synchronization sequence dependent upon the service type.

In an example embodiment and mode the set of synchronization sequences comprises:

a subset of synchronization sequences for a V2X communication service type;

a subset of V2X synchronization sequences for of synchronization sequences for a non-V2X communication service type; and

the processor circuitry selects the selected synchronization sequence from one of (1) and (2).

In an example embodiment and mode the set of synchronization sequences comprises:

a first subset comprising synchronization sequences for which timing is derived from a cellular radio access network node;

a second subset comprising synchronization sequences for which timing is not derived from the cellular radio access network node

a third subset comprising the subset of synchronization sequences for a V2X communication service type;

a fourth subset comprising the subset of synchronization sequences for a non-V2X communication service type. The third subset overlaps with one or both of the first and second subsets but does not overlap with the fourth subset. The processor circuitry is configured to select the selected synchronization sequence as belonging to:

either the first subset of synchronization sequence or the second subset of synchronization sequences; and

either the third subset of synchronization sequences or the fourth subset of synchronization sequences.

In an example embodiment and mode the third subset of synchronization sequences comprises either

(1) only odd numbered members or

(2) only even numbered members

of one or both of the first subset of synchronization sequences and the second subset of synchronization sequences; and

the fourth subset of synchronization sequences comprises members of one or both of the first subset of synchronization sequences and second subset of synchronization sequences that do not belong to the third subset of synchronization sequences.

In an example embodiment and mode the set of synchronization sequences comprises:

a first subset comprising the subset of synchronization sequences for the V2X communication service type;

a second subset comprising the subset of synchronization sequences for the non-V2X communication service type;

a third subset of synchronization sequences which comprises synchronization sequences for which timing is not derived from a cellular radio access network node;

a fourth subset of synchronization sequences which comprises synchronization sequences for which timing is derived from the cellular radio access network node. The third subset of synchronization sequences and the fourth subset of synchronization sequences do not overlap. The processor circuitry is configured to select the selected synchronization sequence as belonging to:

either the first subset of synchronization sequence or the second subset of synchronization sequences; and

either the third subset of synchronization sequences or the fourth subset of synchronization sequences.

In an example embodiment and mode the set of synchronization sequences comprises:

a first subset comprising synchronization sequences for which timing is derived from a cellular radio access network node;

a second subset comprising synchronization sequences for which timing is not derived from the cellular radio access network node;

a third subset comprising the subset of synchronization sequences for a V2X communication service type, the third subset in turn comprising plural further subsets respectively corresponding to plural different V2X communication service types, the plural different V2X communication service types comprising at least two of vehicle-to-vehicle (V2V) communication, vehicle-to-pedestrian (V2P) communication, and vehicle-to-infrastructure (V2I) communication;

a fourth subset comprising the subset of V2X synchronization sequences for of synchronization sequences for the non-V2X communication service type;

wherein the processor circuitry is configured to select the selected synchronization sequence as belonging to:

either the first subset of synchronization sequence or the second subset of synchronization sequences; and

either the third subset of synchronization sequences or the fourth subset of synchronization sequences, and

if belong to the third subset of synchronization sequences, then within the third subset as belonging to one of the plural further subsets.

In an example embodiment and mode the set of synchronization sequences comprises:

a first subset comprising the subset of synchronization sequences for a V2X communication service type, the first subset in turn comprising plural further subsets respectively corresponding to plural different V2X communication service types, the plural different V2X communication service types comprising at least two of vehicle-to-vehicle (V2V) communication, vehicle-to-pedestrian (V2P) communication, and vehicle-to-infrastructure (V2I) communication;

a second subset comprising the subset of V2X synchronization sequences for of synchronization sequences for the non-V2X communication service type;

a third subset of synchronization sequences comprising synchronization sequences for which timing is derived from a cellular radio access network node;

a fourth subset of synchronization sequences comprising synchronization sequences for which timing is not derived from the cellular radio access network node;

wherein the third subset of synchronization sequences and the fourth subset of synchronization sequences do not overlap;

wherein the processor circuitry is configured to select the selected synchronization sequence as belonging to:

either the first subset of synchronization sequences or the second subset of synchronization sequences;

if belong to the first subset of synchronization sequences, then within the first subset as belonging to one of the plural further subsets; and

either the third subset of synchronization sequences or the fourth subset of synchronization sequences.

In an example embodiment and mode the set of synchronization sequences comprises plural subsets respectively corresponding to plural different V2X communication service types, the plural different V2X communication service types comprising at least two of vehicle-to-vehicle (V2V) communication, vehicle-to-pedestrian (V2P) communication, and vehicle-to-infrastructure (V2I) communication; and wherein the processor circuitry is configured to select the selected synchronization sequence as belonging to one of the plural further subsets.

In an example embodiment and mode the synchronization-affecting information is vehicle speed, and wherein the processor circuitry is configured to make the selection of selected synchronization sequence dependent upon a range of vehicle speed.

In an example embodiment and mode the set of synchronization sequences comprises:

a subset of synchronization sequences for a vehicle first speed range;

a subset of synchronization sequences for a vehicle second speed range;

wherein the processor circuitry selects the selected synchronization sequence from one of (1) and (2).

In an example embodiment and mode the set of synchronization sequences comprises:

a first subset comprising synchronization sequences for which timing is derived from a cellular radio access network node;

a second subset comprising synchronization sequences for which timing is not derived from the cellular radio access network node;

a third subset comprising the subset of synchronization sequences for the vehicle first speed range;

a fourth subset comprising the subset of synchronization sequences for the vehicle second speed range;

wherein the third subset overlaps with one or both of the first and second subsets;

wherein the fourth subset overlaps with one or both of the first and second subsets;

wherein the third subset and the fourth subset do not overlap; and

wherein the processor circuitry is configured to select the selected synchronization sequence as belonging to:

either the first subset of synchronization sequence or the second subset of synchronization sequences; and

either the third subset of synchronization sequences or the fourth subset of synchronization sequences.

In an example embodiment and mode the third subset of synchronization sequences comprises either

(1) only odd numbered members or

(2) only even numbered members

of one or both of the first subset of synchronization sequences and the second subset of synchronization sequences; and

the fourth subset of synchronization sequences comprises members of one or both of the first subset of synchronization sequences and second subset of synchronization sequences that do not belong to the third subset of synchronization sequences.

In an example embodiment and mode the set of synchronization sequences comprises:

a first subset comprising subset of synchronization sequences for the vehicle first speed range;

a second subset comprising subset of synchronization sequences for the vehicle second speed range;

a third subset of synchronization sequences which comprises synchronization sequences for which timing is derived from a cellular radio access network node;

a fourth subset of synchronization sequences which comprises synchronization sequences for which timing is not derived from the cellular radio access network node;

wherein the third subset of synchronization sequences and the fourth subset of synchronization sequences do not overlap;

wherein the processor circuitry is configured to select the selected synchronization sequence as belonging to:

either the first subset of synchronization sequence or the second subset of synchronization sequences; and

either the third subset of synchronization sequences or the fourth subset of synchronization sequences.

In an example embodiment and mode the set of synchronization sequences comprises plural subsets respectively corresponding to plural different ranges of vehicle speed, and wherein the processor circuitry selects the selected synchronization sequence from one of the plural different ranges of vehicle speed.

In another of its aspects the technology disclosed herein concerns a wireless terminal comprising processing circuitry and a transmitter. The processor circuitry circuitry is configured prepare content for a synchronization signal for wireless vehicle direct (V2X) communication and a broadcast channel for the vehicle (V2X) communication. The processor circuitry is configured to include in the broadcast channel for the wireless vehicle (V2X) communication a V2X service type indication of as to which of plural different V2X communication service types the V2X communication pertains, the plural different V2X communication service types comprising at least two of vehicle-to-vehicle (V2V) communication, vehicle-to-pedestrian (V2P) communication, and vehicle-to-infrastructure (V2I) communication. The transmitter is configured to transmit the synchronization signal and the broadcast channel comprising the V2X service type indication over a radio interface.

In another of its aspects the technology disclosed herein concerns wireless terminal comprising processing circuitry and a transmitter. The processor circuitry is configured prepare content for a synchronization signal for wireless vehicle direct (V2X) communication and a broadcast channel for the wireless vehicle (V2X) communication, and wherein the processor circuitry is configured to include in the broadcast channel for the wireless vehicle (V2X) communication an indication of vehicle speed. The transmitter is configured to transmit the synchronization signal and the broadcast channel comprising the indication of vehicle speed.

In another of its aspects the technology disclosed herein concerns a wireless terminal comprising receiver circuitry and processing circuitry. The receiver circuitry is configured to receive a synchronization signal over a radio interface. The processor circuitry is configured to ascertain, from a received synchronization sequence which is included in the synchronization signal and which belongs to a set of synchronization sequences, synchronization-affecting information used for a wireless vehicle (V2X) communication.

In an example embodiment and mode the processor configured to ascertain, from the received synchronization sequence which is included in the synchronization signal and which belongs to the set of synchronization sequences, plural synchronization-affecting parameters used for a wireless vehicle (V2X) communication.

In an example embodiment and mode the plural synchronization-affecting parameters comprise timing source used for the V2X communication and service type, and wherein the processor is configured to ascertain one or more subsets to the received synchronization sequence belongs, the timing source used for the V2X communication and the service type of the communication.

In an example embodiment and mode the plural synchronization-affecting parameters comprise service type and speed of a vehicle participating in the V2X communication, and wherein the processor circuitry is configured to ascertain one or more subsets to the received synchronization sequence belongs, the service type and the speed of the vehicle participating in the V2X communication.

In an example embodiment and mode the plural synchronization-affecting parameters comprise timing source used for the V2X communication, service type, and speed of a vehicle participating in the V2X communication, and wherein the processor circuitry is configured to ascertain one or more subsets to the received synchronization sequence belongs, the timing source used for the V2X communication, the service type of the communication, and the speed of the vehicle participating in the V2X communication.

In an example embodiment and mode the processor circuitry is configured to ascertain a value of the synchronization-affecting parameter in dependence upon to which of plural subsets of synchronization sequences the received synchronization sequence belongs.

In an example embodiment and mode the synchronization-affecting information is a timing source used for the V2X communication, and wherein the processor circuitry is configured to ascertain, from a subset of synchronization sequences to which the received synchronization sequence belongs, the timing source used for the V2X communication.

In an example embodiment and mode the set of synchronization sequences comprises:

a subset of V2X synchronization sequences for which timing for the V2X communication is obtained with respect to a first timing source;

a subset of V2X synchronization sequences for which timing for the V2X communication is obtained from a second timing source; and

wherein the processor circuitry is configured to ascertain information regarding the timing source dependent upon whether the received synchronization sequence belongs to (1) or (2).

wherein the first timing source is a source is a timing source available throughout a cellular radio access network but maintained external to the cellular radio access network and the second timing source is maintained by the cellular radio access network.

wherein the first timing source is a Global Navigation Satellite System (GNSS) timing source.

In an example embodiment and mode the set of synchronization sequences comprises:

a first subset comprising synchronization sequences for which timing is derived from a cellular radio access network node;

a second subset comprising synchronization sequences for which timing is not derived from the cellular radio access network node;

a third subset comprising the V2X synchronization sequences for which timing for the V2X communication is obtained with respect to the first timing source;

a fourth subset comprising the V2X synchronization sequences for which timing for the V2X communication is obtained with respect to the second timing source;

wherein the third subset overlaps with one or both of the first and second subsets but does not overlap with the fourth subset; and

wherein the processor circuitry is configured to ascertain information regarding the timing source dependent on the received synchronization sequence belong to either the third subset of synchronization sequences or the fourth subset of synchronization sequences.

In an example embodiment and mode

the third subset of synchronization sequences comprises either only odd numbered members or only even numbered members of one or both of the first subset of synchronization sequences and the second subset of synchronization sequences; and

the fourth subset of synchronization sequences comprises members of one or both of the first subset of synchronization sequences and second subset of synchronization sequences that do not belong to the third subset of synchronization sequences.

In an example embodiment and mode the set of synchronization sequences comprises:

a first subset comprising the V2X synchronization sequences for which timing for the V2X communication is obtained with respect to the first timing source;

a second subset comprising the V2X synchronization sequences for which timing for the V2X communication is obtained with respect to the second timing source;

a third subset of synchronization sequences which is a subset of the second subset of synchronization sequence and which comprises synchronization sequences for which timing is derived from a cellular radio access network node;

a fourth subset of synchronization sequences which is a subset of the second subset of synchronization sequence and which comprises synchronization sequences for which timing is not derived from the cellular radio access network node;

wherein the third subset of synchronization sequences and the fourth subset of synchronization sequences do not overlap;

wherein the processor circuitry is configured to ascertain information regarding the timing source depending on whether the received synchronization sequence belongs to the first subset of synchronization sequence or the second subset of synchronization sequences.

In an example embodiment and mode the wireless terminal the synchronization-affecting information is service type, a first service type being sidelink direct communication and a second service type being V2X communication, and wherein the processor circuitry is configured to ascertain, from a subset of synchronization sequences to which the received synchronization sequence belongs, the service type used for the wireless communication.

In an example embodiment and mode the set of synchronization sequences comprises a subset of synchronization sequences for a V2X communication service type; a subset of V2X synchronization sequences for of synchronization sequences for a non-V2X communication service type; and wherein the processor circuitry ascertains the service type dependent on whether the received synchronization sequence belongs to (1) or (2).

In an example embodiment and mode the set of synchronization sequences comprises:

a first subset comprising synchronization sequences for which timing is derived from a cellular radio access network node;

a second subset comprising synchronization sequences for which timing is not derived from the cellular radio access network node;

a third subset comprising the subset of synchronization sequences for a V2X communication service type;

a fourth subset comprising the subset of synchronization sequences for a non-V2X communication service type;

wherein the third subset overlaps with one or both of the first and second subsets but does not overlap with the fourth subset; and

wherein the processor circuitry is configured to ascertain the service type depending on whether the received synchronization sequence belongs to the third subset of synchronization sequences or the fourth subset of synchronization sequences.

In an example embodiment and mode

the third subset of synchronization sequences comprises either

(1) only odd numbered members or

(2) only even numbered members

of one or both of the first subset of synchronization sequences and the second subset of synchronization sequences; and

the fourth subset of synchronization sequences comprises members of one or both of the first subset of synchronization sequences and second subset of synchronization sequences that do not belong to the third subset of synchronization sequences.

In an example embodiment and mode the set of synchronization sequences comprises:

a first subset comprising the subset of synchronization sequences for the V2X communication service type;

a second subset comprising the subset of synchronization sequences for the non-V2X communication service type;

a third subset of synchronization sequences which comprises synchronization sequences for which timing is derived from a cellular radio access network node;

a fourth subset of synchronization sequences which comprises synchronization sequences for which timing is not derived from the cellular radio access network node;

wherein the third subset of synchronization sequences and the fourth subset of synchronization sequences do not overlap;

wherein the processor circuitry is configured to ascertain the service type depending on whether the received synchronization sequence belongs to the first subset of synchronization sequence or the second subset of synchronization sequences.

In an example embodiment and mode the set of synchronization sequences comprises:

a first subset comprising synchronization sequences for which timing is derived from a cellular radio access network node;

a second subset comprising synchronization sequences for which timing is not derived from the cellular radio access network node;

a third subset comprising the subset of synchronization sequences for a V2X communication service type, the third subset in turn comprising plural further subsets respectively corresponding to plural different V2X communication service types, the plural different V2X communication service types comprising at least two of vehicle-to-vehicle (V2V) communication, vehicle-to-pedestrian (V2P) communication, and vehicle-to-infrastructure (V2I) communication;

a fourth subset comprising the subset of V2X synchronization sequences for of synchronization sequences for the non-V2X communication service type;

wherein the processor circuitry is configured to ascertain the service type depending on whether the synchronization sequence belongs to:

either the third subset of synchronization sequences or the fourth subset of synchronization sequences, and

if belonging to the third subset of synchronization sequences, then within the first third as belonging to one of the plural further subsets.

In an example embodiment and mode the set of synchronization sequences comprises:

a first subset a comprising the subset of synchronization sequences for a V2X communication service type, the first subset in turn comprising plural further subsets respectively corresponding to plural different V2X communication service types, the plural different V2X communication service types comprising at least two of vehicle-to-vehicle (V2V) communication, vehicle-to-pedestrian (V2P) communication, and vehicle-to-infrastructure (V2I) communication;

a second subset comprising the subset of V2X synchronization sequences for of synchronization sequences for the non-V2X communication service type;

a third subset of synchronization sequences which is a subset of the second subset of synchronization sequence and which comprises synchronization sequences for which timing is derived from a cellular radio access network node;

a fourth subset of synchronization sequences which is a subset of the second subset of synchronization sequence and which comprises synchronization sequences for which timing is not derived from the cellular radio access network node;

wherein the third subset of synchronization sequences and the fourth subset of synchronization sequences do not overlap;

wherein the processor circuitry is configured to ascertain the service type depending on whether the received synchronization sequence belongs to:

either the first subset of synchronization sequences or the second subset of synchronization sequences;

if belong to the first subset of synchronization sequences, then ascertaining to which of the plural further subsets the received synchronization sequence belongs.

In an example embodiment and mode the set of synchronization sequences comprises plural subsets respectively corresponding to plural different V2X communication service types, the plural different V2X communication service types comprising at least two of vehicle-to-vehicle (V2V) communication, vehicle-to-pedestrian (V2P) communication, and vehicle-to-infrastructure (V2I) communication; and wherein the processor circuitry is configured to ascertain the service type depending on whether the received synchronization sequence as belonging to one of the plural further subsets.

In an example embodiment and mode the synchronization-affecting information is vehicle speed, and wherein the processor circuitry is configured to ascertain, from a subset of synchronization sequences to which the received synchronization sequence belongs, a range of vehicle speed for the vehicle involved in the wireless communication.

In an example embodiment and mode the set of synchronization sequences comprises:

a subset of synchronization sequences for a vehicle first speed range;

a subset of synchronization sequences for a vehicle second speed range;

wherein the processor circuitry ascertains the range of the vehicle speed depending on whether the received synchronization sequence belongs to (1) or (2).

In an example embodiment and mode the set of synchronization sequences comprises:

a first subset comprising synchronization sequences for which timing is derived from a cellular radio access network node;

a second subset comprising synchronization sequences for which timing is not derived from the cellular radio access network node;

a third subset comprising the subset of synchronization sequences for the vehicle first speed range;

a fourth subset comprising the subset of synchronization sequences for the vehicle second speed range;

wherein the third subset overlaps with one or both of the first and second subsets;

wherein the fourth subset overlaps with one or both of the first and second subsets;

wherein the third subset and the fourth subset do not overlap; and

wherein the processor circuitry is configured to ascertain the range of vehicle speed depending on whether the received synchronization sequence belongs to either the third subset of synchronization sequences or the fourth subset of synchronization sequences.

In an example embodiment and mode the third subset of synchronization sequences comprises either

(1) only odd numbered members or

(2) only even numbered members

of one or both of the first subset of synchronization sequences and the second subset of synchronization sequences; and

the fourth subset of synchronization sequences comprises members of one or both of the first subset of synchronization sequences and second subset of synchronization sequences that do not belong to the third subset of synchronization sequences.

In an example embodiment and mode the set of synchronization sequences comprises:

a first subset comprising subset of synchronization sequences for the vehicle first speed range;

a second subset comprising subset of synchronization sequences for the vehicle second speed range;

a third subset of synchronization sequences which comprises synchronization sequences for which timing is derived from a cellular radio access network node;

a fourth subset of synchronization sequences which comprises synchronization sequences for which timing is not derived from the cellular radio access network node;

wherein the third subset of synchronization sequences and the fourth subset of synchronization sequences do not overlap;

wherein the processor circuitry is configured to ascertain the range of vehicle speed depending on whether the received synchronization sequence belongs to the first subset of synchronization sequence or the second subset of synchronization sequences.

In an example embodiment and mode the set of synchronization sequences comprises plural subsets respectively corresponding to plural different ranges of vehicle speed, and wherein the processor circuitry ascertains the range of vehicle speed depending on to which of the plural different ranges of vehicle speed the received synchronization sequence belongs.

In another of its aspects the technology disclosed herein concerns a wireless terminal comprising receiver circuitry and processing circuitry. The receiver circuitry is configured to receive a synchronization signal and a broadcast channel over a radio interface. The processor circuitry configured to ascertain from the broadcast channel a V2X service type indication as to which of plural different V2X communication service types a V2X communication pertains, the plural different V2X communication service types comprising at least two of vehicle-to-vehicle (V2V) communication, vehicle-to-pedestrian (V2P) communication, and vehicle-to-infrastructure (V2I) communication.

In another of its aspects the technology disclosed herein concerns a wireless terminal comprising receiver circuitry and processing circuitry. The receiver circuitry is configured to receive a synchronization signal and a broadcast channel over a radio interface. The processor circuitry configured to ascertain from the broadcast channel an indication of vehicle speed of a vehicle involved in a V2X communication.

In one of its aspects the technology disclosed herein concerns a method of operating a wireless terminal comprising:

using processor circuitry to prepare content for a synchronization signal for wireless vehicle direct (V2X) communication by making a selection of a selected synchronization sequence from a set of synchronization sequences, the selection being dependent upon synchronization-affecting information used for the V2X communication;

transmitting the synchronization signal comprising the selected synchronization sequence over a radio interface.

In one of its aspects the technology disclosed herein concerns a method of operating a wireless terminal comprising:

receiving a synchronization signal over a radio interface;

using processor circuitry to ascertain, from a received synchronization sequence which is included in the synchronization signal and which belongs to a set of synchronization sequences, synchronization-affecting information used for wireless vehicle direct (V2X) communication.

Although the description above contains many specificities, these should not be construed as limiting the scope of the technology disclosed herein but as merely providing illustrations of some of the presently preferred embodiments of the technology disclosed herein. Thus the scope of the technology disclosed herein should be determined by the appended claims and their legal equivalents. Therefore, it will be appreciated that the scope of the technology disclosed herein fully encompasses other embodiments which may become obvious to those skilled in the art, and that the scope of the technology disclosed herein is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the technology disclosed herein, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A user equipment (UE) comprising:
control circuitry configured to select one sidelink synchronization signal (SLSS) sequence from multiple SLSS sequences; and
transmission circuitry configured to transmit a SLSS which is generated by using the selected SLSS sequence; wherein
the multiple SLSS sequences consists of a first subset and a second subset, the first subset being for in-network-coverage, the second subset being for out-of-network-coverage, and
the first subset includes a third subset, the third subset corresponding to Global Navigation Satellite System (GNSS) timing.

2. A method for a user equipment (UE), the method comprising:
selecting one sidelink synchronization signal (SLSS) sequence from multiple SLSS sequences; and
transmitting a SLSS which is generated by using the selected SLSS sequence; wherein
the multiple SLSS sequences consists of a first subset and a second subset, the first subset being for in-network-coverage, the second subset being for out-of-network-coverage, and
the first subset includes a third subset, the third subset corresponding to Global Navigation Satellite System (GNSS) timing.

3. A wireless terminal comprising:
processor circuitry is configured to prepare content for a synchronization signal for a wireless vehicle (V2X) communications by making a selection of a selected synchronization sequence from a set of synchronization sequences, the selection being dependent upon synchronization-affecting information used for the V2X communication;
a transmitter configured to transmit the synchronization signal comprising the selected synchronization sequence over a radio interface.
